(19) United States
(12) Patent Application Publication
(10) Pub. No.: US 2006/0023577 A1
(43) Pub. Date: Feb. 2, 2006

(54) Optical recording and reproduction method, optical pickup device, optical recording and reproduction device, optical recording medium and method of manufacture the same, as well as semiconductor laser device

(76) Inventors: Masataka Shinoda, Kanagawa (JP); Kimihiro Saito, Saitama (JP); Toshihiro Horigome, Kanagawa (JP); Motohiro Furuki, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/165,284

(22) Filed: Jun. 24, 2005

(30) Foreign Application Priority Data
Jun. 25, 2004 (JP) 2004-188283

(51) Int. Cl. G11B 7/00

(52) U.S. Cl. 369/44.23; 369/112.23

(57) ABSTRACT

An optical recording and reproduction method, optical pickup device, and optical recording and reproduction device are provided, in which an optical recording medium is irradiated with near-field light to perform recording and/or reproduction, and wherein two or more recording and reproduction beam spots are positioned in a recording and reproduction area between guide tracks on the optical recording medium to perform recording and/or reproduction, as a consequence of which application to near-field optical recording and reproduction is ideally performed, and high transfer rates become possible.

### CROSS-REFERENCES TO RELATED APPLICATIONS

The present invention contains subject matter related to Japanese Patent Application JP 2004-188283, filed in the Japanese Patent Office on Jun. 25, 2004, the entire contents of which being incorporated herein by reference.

### BACKGROUND OF THE INVENTION

1. Field of the Invention

This invention relates to an optical recording and reproduction method, optical pickup device, optical recording and reproduction device, optical recording media and method of manufacturing thereof, and semiconductor laser device, which are particularly suitable for a so-called near-field optical recording and reproduction method, in which an optical recording medium is irradiated with near-field light to perform recording and/or reproduction.

2. Description of the Related Art

Optical (or magneto-optical) recording media, of which compact discs (CDs), minidiscs (MDs), and digital versatile discs (DVDs) are representative, are widely used as media for storing music, video and still images, data, programs, and similar. However, due to movements toward enhanced sound and image quality, longer play times, and greater data volumes for such music, video, data, program and other data, optical recording media with still greater storage capacities, and optical recording and reproduction devices for recording to and reproducing from such media, are desired.

In order to accommodate such demands, efforts have been made with respect to optical recording and reproduction devices to shorten the wavelengths of light sources such as semiconductor lasers and to increase the numerical apertures of focusing lenses, as well as to reduce the diameters of the light spots focused by focusing lenses.

For example, where semiconductor lasers are concerned, GaN semiconductor lasers with oscillation wavelengths shortened from the 635 nm of conventional red-light lasers to the 400 nm band have been commercialized, and this has been accompanied by reductions in the diameter of the laser spot. As part of movements toward still shorter wavelengths, far-ultraviolet solid state laser UW-1010 produced by Sony Corporation, continuously oscillating to emit light at a single wavelength of 266 nm, and other devices have been commercialized; and efforts are underway to further reduce the light spot size. Other devices under research and development include a second-harmonic Nd:YAG laser (266 nm band), diamond laser (235 nm band), and second-harmonic GaN laser (202 nm band).

Further, an optical lens with large numerical aperture, of which a solid immersion lens is representative, may be used to obtain a focusing lens with a numerical aperture of one or greater, for example; moreover, near-field optical recording and reproduction methods are being studied, in which the objective surface of the focusing lens is brought to within approximately one-tenth the light source wavelength from the optical recording medium to perform recording and reproduction.

In order to increase the transfer rate in such near-field optical recording and reproduction methods, it is important that the distance between the optical recording medium and the focusing lens be maintained in a state of optical contact while rotating the disc at high speed.

In order to obtain an optical recording medium with high recording density of the order of 100 Gbits/inch² which supports such near-field optical recording and reproduction methods, a recording track width must be reduced to approximately 100 nm or less. Manufacture using electron beam exposure, for example, is possible, but further reduction of the track width is difficult.

On the other hand, a method has been proposed in which the recording density remains unchanged, but the signal transfer rate is increased by reproducing data from two tracks simultaneously (see Patent Reference 1, for example).
Patent Reference 1: Published Japanese Patent Application No. 2003-272176

### SUMMARY OF THE INVENTION

In the optical recording medium according to the above Patent Reference 1, a method is employed in which recording tracks existing on both sides of a single tracking track (guide groove) are irradiated by two beam spots to perform recording and reproduction.

However, in the technology disclosed in Patent Reference 1, the specific method of adjusting the interval (gap) between the near-field irradiation means, for example, a solid immersion lens, and the optical recording medium when irradiating the optical recording medium with near-field light is not considered.

This invention is to propose an optical recording and reproduction method and optical pickup device suitable for application in the above-described near-field optical recording and reproduction method, and which enable improved transfer rates, as well as to provide an optical recording and reproduction device, optical recording medium and manufacturing method therefor, and semiconductor laser device employing the above method and pickup device.

In order to achieve the above, an optical recording and reproduction method according to an embodiment of this invention includes the steps of irradiating an optical recording medium with near-field light, and positioning two or more recording and reproduction beam spots in a recording and reproduction area between the above-described guide tracks on the optical recording medium to perform recording and/or reproduction.

Further, in the above-described optical recording and reproduction method of this invention, at least one among the beam spots, or else a beam spot or spots provided separately therefrom, are gap detection beam spots which detect the interval between the near-field light irradiation means and the surface of the optical recording medium.

Further, in the above-described optical recording and reproduction method of this invention, light of different wavelengths is used in irradiation of, at least, the recording and reproduction beam spots, and the gap detection beam spots.

Further, in the above-described optical recording and reproduction method of this invention, at least the above recording and reproduction beam spots are positioned at approximately equal intervals in the recording and reproduction area between the guide tracks.

Further, in the above-described optical recording and reproduction method of this invention, the gap detection beam spots are positioned approximately at the center of the recording and reproduction area between the guide tracks, or at positions symmetrical about the center position.

Further, in the above-described optical recording and reproduction method of this invention, the starting interval distance of any one among guide tracks, pits, wobbles, or recording marks, positioned on the optical recording medium, is used to calculate the beam positioning interval of the two or more recording and reproduction beam spots.

An optical pickup device according to an embodiment of this invention is configured to use the above-described optical recording and reproduction method of this invention. That is, an optical pickup device according to an embodiment of this invention includes at least near-field light irradiation means to irradiate an optical recording medium with light from a light source, in which two or more recording and reproduction beam spots are positioned in a recording and reproduction area between guide tracks of the optical recording medium.

Further, in the above-described optical pickup device of this invention, at least one among the above beam spots, or else a separately provided beam spot or spots, are employed as gap detection beam spots to detect the interval between the near-field light irradiation means and the surface of the optical recording medium.

Further, in the above-described optical pickup device of this invention, at least different wavelengths are used for the recording and reproduction beam spots, and for the gap detection beam spots.

Further, in the above-described optical pickup device of this invention, at least the recording and reproduction beam spots are positioned at approximately equal intervals in the recording and reproduction area between the guide tracks.

Further, in the above-described optical pickup device of this invention, the gap detection beam spots are positioned approximately in the center of, or at positions symmetrical about the center position of, the recording and reproduction area between the guide tracks.

Further, in the above-described optical pickup device of this invention, the starting interval distance of any one among guide tracks, pits, wobbles, or recording marks, positioned on the optical recording medium, is used to calculate the beam positioning interval of the two or more recording and reproduction beam spots.

Further, an optical recording and reproduction device according to an embodiment of this invention includes, at least, near-field light irradiation means to irradiate an optical recording medium with light from a light source and perform recording and/or reproduction, in which two or more recording and reproduction beam spots are positioned in a recording and reproduction area between guide tracks on the optical recording medium.

An optical recording medium according to an embodiment of this invention is the optical recording medium irradiated with near-field light to perform recording and/or reproduction, including two or more recording tracks, in which recording and/or reproduction are performed synchronously, are positioned in an area between guide tracks.

An optical recording and reproduction method according to another embodiment of this invention includes the steps of irradiating an optical recording medium with near-field light, positioning two or more recording and reproduction beam spots in recording and reproduction areas on both sides of a guide track on the optical recording medium to perform recording and/or reproduction, and positioning a gap detection beam spot which detects the interval between the near-field light irradiation means and the surface of the optical recording medium on the guide track.

Further, in the above-described optical recording and reproduction method of this invention, at least light of different wavelengths is used for the recording and reproduction beam spots, and for the gap detection beam spots.

Further, in the above-described optical recording and reproduction method of this invention, at least the above recording and reproduction beam spots are positioned at approximately equal intervals in recording and reproduction areas on both sides of the guide track.

Further, in the above-described optical recording and reproduction method of this invention, the starting interval distance of any one among guide tracks, pits, wobbles, or recording marks, positioned on the optical recording medium, is used to calculate the beam positioning interval of the two or more recording and reproduction beam spots.

An optical pickup device according to another embodiment of this invention is configured using the above-described optical recording and reproduction method of this invention. That is, an optical pickup device includes, at least, near-field light irradiation means to irradiate an optical recording medium with light from a light source, in which two or more recording and reproduction beam spots are positioned in recording and reproduction areas on both sides of a guide track on the optical recording medium to perform recording and/or reproduction, and a gap detection beam spot, which detects the interval between the near-field light irradiation means and the surface of the optical recording medium, is positioned on the guide track.

Further, in the above-described optical pickup device of this invention, at least light of different wavelengths is used for the recording and reproduction beam spots, and for the gap detection beam spot.

Further, in the above-described optical pickup device of this invention, at least the recording and reproduction beam spots are positioned at approximately equal intervals in the recording and reproduction areas on both sides of the guide track.

Further, in the above-described optical pickup device of this invention, the starting interval distance of any one among guide tracks, pits, wobbles, or recording marks, positioned on the optical recording medium, is used to calculate the beam positioning interval of the two or more recording and reproduction beam spots.

An optical recording and reproduction device according to another embodiment of this invention is configured including the above-described optical pickup device according to another embodiment of this invention. That is, the optical recording and reproduction device includes, at least, near-field light irradiation means to irradiate an optical recording medium with light from a light source and perform recording and/or reproduction, in which two or more recording and reproduction beam spots are positioned in recording and reproduction areas on both sides of a guide track on the optical recording medium to perform recording and/or reproduction, and a gap detection beam spot which detects the interval between the near-field light irradiation means and the surface of the optical recording medium is positioned on the guide track.

An optical recording medium manufacturing method according to an embodiment of this invention is a method of manufacturing an optical recording medium for recording and/or reproduction using near-field light, including the step of forming at least a portion of the guide track, pits, or wobbles of the optical recording medium master used to manufacture the above-described optical recording medium by high-speed blanking lithography using an electron beam lithography system.

A semiconductor laser device according to an embodiment of this invention includes two or more semiconductor lasers stacked, in which at least one of these semiconductor lasers has two or more emission surfaces, and either at least one emission surface among all the emission surfaces of the semiconductor lasers is positioned approximately in the center position of a line connecting both surfaces of an array of other emission surfaces, or two or more emission surfaces are positioned at positions symmetrical with respect to the center position.

Further, in the above-described semiconductor laser device of this invention, a semiconductor laser having either an emission surface positioned approximately in the center position, or having emission surfaces positioned in positions symmetrical about the center position, emits laser light with a wavelength different from that of semiconductors having other emission surfaces.

According to the embodiments of an optical recording and reproduction method and optical pickup device of this invention, a plurality of recording and reproduction beam spots are used to perform recording and/or reproduction, and consequently higher transfer rates for recording and reproduction signals can be achieved compared with an optical recording medium of the related art, without the high-speed rotation of the medium.

Moreover, according to the embodiments of this invention, at least one among a plurality of beam spots, or else a separately provided beam spot, is used as a beam spot for gap detection, so that the interval between the near-field light irradiation means and the surface of the optical recording medium can be controlled more efficiently and accurately, and the stability of near-field recording to and reproduction from the optical recording medium can be improved.

Further, according to the embodiments of this invention, light of different wavelengths is used for the recording and reproduction beam spots, and for the gap detection beam spot, so that signal reproduction characteristics are improved to further enhance the stability of recording and reproduction.

Further, according to the embodiments of this invention, by positioning at least recording and reproduction beam spots at approximately equal intervals in recording and reproduction areas on both sides of a guide track, crosstalk and intersymbol interference can be controlled, and the stability of recording and reproduction can further be improved.

Further, according to the embodiments of this invention, by positioning a gap detection beam spot at approximately the center position, or at positions symmetrical about the center position of the recording and reproduction area between guide tracks, the recording and reproduction beam spot irradiation position, or the interval between the nearby near-field light irradiation means and the surface of the optical recording medium, can be reliably detected and accurately controlled.

Further, according to the embodiments of this invention, the starting interval distance of any one among guide tracks, pits, wobbles, or recording marks, positioned on the optical recording medium, is used to calculate the positioning interval of two or more recording and reproduction beam spots, so that the stability of recording and reproduction can be improved.

Further, according to the embodiments of an optical recording and reproduction device and optical recording medium of this invention, the recording and reproduction signal transfer rate can be increased without high-speed rotation of the optical recording medium.

Further, according to the embodiments of an optical recording and reproduction method and optical pickup device of this invention, a plurality of recording and reproduction beam spots are used to perform recording and/or reproduction, and by positioning a gap detection beam spot on the guide track, the interval between the near-field light irradiation means and the surface of the optical recording medium can be controlled efficiently and accurately, and the stability of near-field recording to and reproduction from the optical recording medium can be improved.

Further, according to the embodiments of an optical recording medium manufacturing method of this invention, at least a portion of the guide track, pits, or wobbles is formed by high-speed blanking lithography using an electron beam lithography system, so that of the signals reproduced by irradiation using a plurality of recording and reproduction beam spots, tracking can be performed satisfactorily even for beam spots positioned on the inside of the guide track, signal recording and reproduction can be performed accurately, and the stability of recording and reproduction can be improved.

Further, according to the embodiments of a semiconductor laser device of this invention, the semiconductor laser device is used as the light source of an optical pickup device based on near-field recording and reproduction, high transfer rates can be attained without high-speed rotation of the optical recording medium.

### BRIEF DESCRIPTION OF THE DRAWINGS

FIG. 1 is a schematic constitutional diagram showing a relevant portion of an optical pickup device according to an embodiment of this invention;

FIG. 2 is a schematic constitutional diagram showing an optical pickup device according to an embodiment of this invention;

FIG. 3 is a schematic constitutional diagram showing beam positioning in an optical recording and reproduction method according to an embodiment of this invention;

FIG. 4 is a schematic constitutional diagram showing beam positioning in an optical recording and reproduction method according to an embodiment of this invention; FIG. 5 is a schematic constitutional diagram showing beam positioning in an optical recording and reproduction method according to an embodiment of this invention;

FIG. 6 is a schematic constitutional diagram showing beam positioning in an optical recording and reproduction method according to an embodiment of this invention;

FIG. 7 is a schematic constitutional diagram showing beam positioning in an optical recording and reproduction method according to an embodiment of this invention;

FIG. 8 is a schematic constitutional diagram showing beam positioning in an optical recording and reproduction method according to an embodiment of this invention;

FIG. 9A is a schematic sectional and constitutional diagram showing a relevant part of a semiconductor laser device according to an embodiment of this invention;

FIG. 9B is a schematic sectional and constitutional diagram showing a relevant part of a semiconductor laser device according to an embodiment of this invention;

FIG. 10 is a diagram showing changes in the amount of totally reflected return light with the gap;

FIG. 11 is a schematic constitutional diagram showing an optical pickup device according to an embodiment of this invention;

FIG. 12 is a schematic constitutional diagram showing beam positioning in an optical recording and reproduction method according to an embodiment of this invention;

FIG. 13 is a schematic constitutional diagram showing beam positioning in an optical recording and reproduction method according to an embodiment of this invention;

FIG. 14 is a schematic constitutional diagram showing beam positioning in an optical recording and reproduction method according to an embodiment of this invention;

FIG. 15 is a schematic constitutional diagram showing beam positioning in an optical recording and reproduction method according to an embodiment of this invention;

FIG. 16 is a schematic sectional and constitutional diagram showing a relevant part of a semiconductor laser device according to an embodiment of this invention;

FIG. 17 is a schematic constitutional diagram showing beam positioning in an optical recording and reproduction method according to an embodiment of this invention;

FIG. 18 is a schematic constitutional diagram showing beam positioning in an optical recording and reproduction method according to an embodiment of this invention;

FIG. 19 is a schematic sectional and constitutional diagram showing a relevant part of a semiconductor laser device according to an embodiment of this invention;

FIG. 20 is a schematic constitutional diagram showing beam positioning in an optical recording and reproduction method according to an embodiment of this invention;

FIG. 21 is a schematic constitutional diagram showing beam positioning in an optical recording and reproduction method according to an embodiment of this invention is a schematic constitutional diagram showing;

FIG. 22 is a schematic sectional and constitutional diagram showing a relevant part of an example of an optical recording medium;

FIG. 23 is a diagram showing the relation between the gap and the amount of totally reflected return light;

FIG. 24 is a schematic sectional and constitutional diagram showing a relevant part of an example of an optical recording medium;

FIG. 25 is a diagram showing the relation between the gap and the amount of totally reflected return light;

FIG. 26 is a schematic constitutional diagram showing beam positioning in an optical recording and reproduction method according to an embodiment of this invention;

FIG. 27 is a schematic constitutional diagram showing beam positioning in an optical recording and reproduction method according to an embodiment of this invention;

FIG. 28 is a schematic constitutional diagram showing beam positioning in an optical recording and reproduction method according to an embodiment of this invention;

FIG. 29 is a schematic constitutional diagram showing beam positioning in an optical recording and reproduction method according to an embodiment of this invention;

FIG. 30 is a schematic constitutional diagram showing beam positioning in an optical recording and reproduction method according to an embodiment of this invention;

FIG. 31 is a schematic constitutional diagram showing beam positioning in an optical recording and reproduction method according to an embodiment of this invention;

FIG. 32 is a schematic constitutional diagram showing beam positioning in an optical recording and reproduction method according to an embodiment of this invention;

FIG. 33 is a schematic constitutional diagram showing beam positioning in an optical recording and reproduction method according to an embodiment of this invention;

FIG. 34 is a schematic constitutional diagram showing beam positioning in an optical recording and reproduction method according to an embodiment of this invention;

FIG. 35 is a schematic constitutional diagram showing a relevant part of an optical recording medium fabricated by an optical recording medium manufacturing method according to an embodiment of this invention;

FIG. 36 is a schematic constitutional diagram showing a relevant part of an optical recording medium fabricated by an optical recording medium manufacturing method according to an embodiment of this invention;

FIG. 37 is a schematic constitutional diagram showing a relevant part of an optical recording medium fabricated by an optical recording medium manufacturing method according to an embodiment of this invention;

FIG. 38 is a schematic constitutional diagram showing a relevant part of an optical recording medium fabricated by an optical recording medium manufacturing method according to an embodiment of this invention;

FIG. 39A is a schematic perspective diagram showing a relevant part of an example of an optical recording medium;

FIG. 39B is a schematic perspective diagram showing a relevant part of an example of an optical recording medium;

FIG. 40A is a schematic sectional diagram showing a relevant part of an example of an optical recording medium;

FIG. 40B is a schematic sectional diagram showing a relevant part of an example of an optical recording medium;

FIG. 41A is a schematic sectional diagram showing a relevant part of an example of an optical recording medium;

FIG. 41B is a schematic sectional diagram showing a relevant part of an example of an optical recording medium;

FIG. 42A is a schematic sectional diagram showing a relevant part of an example of an optical recording medium;

FIG. 42B is a schematic sectional diagram showing a relevant part of an example of an optical recording medium;

FIG. 43A is a schematic sectional diagram showing a relevant part of an example of an optical recording medium;

FIG. 43B is a schematic sectional diagram showing a relevant part of an example of an optical recording medium;

FIG. 44A is a schematic sectional diagram showing a relevant part of an example of an optical recording medium;

FIG. 44B is a schematic sectional diagram showing a relevant part of an example of an optical recording medium;

FIG. 45A is a schematic sectional diagram showing a relevant part of an example of an optical recording medium;

FIG. 45B is a schematic sectional diagram showing a relevant part of an example of an optical recording medium;

FIG. 45C is a schematic sectional diagram showing a relevant part of an example of an optical recording medium;

FIG. 45D is a schematic sectional diagram showing a relevant part of an example of an optical recording medium;

FIG. 46 is a schematic constitutional diagram showing beam positioning in an optical recording and reproduction method according to an embodiment of this invention;

FIG. 47 is a diagram showing examples of waveforms of pit reproduction signals;

FIG. 48 is a schematic constitutional diagram showing beam positioning in an optical recording and reproduction method according to an embodiment of this invention;

FIG. 49 is a diagram schematically showing an example of pits and recording and reproduction signals;

FIG. 50 is a schematic constitutional diagram showing beam positioning in an optical recording and reproduction method according to an embodiment of this invention;

FIG. 51 is a diagram showing examples of waveforms of pit reproduction signals;

FIG. 52 is a schematic constitutional diagram showing beam positioning in an optical recording and reproduction method according to an embodiment of this invention;

FIG. 53 is a diagram schematically showing an example of pits and recording and reproduction signals;

FIG. 54 is a schematic constitutional diagram showing beam positioning in an optical recording and reproduction method according to an embodiment of this invention;

FIG. 55 is a diagram showing examples of waveforms of pit reproduction signals;

FIG. 56 is a schematic constitutional diagram showing beam positioning in an optical recording and reproduction method according to an embodiment of this invention;

FIG. 57 schematically shows an example of pits and recording and reproduction signals;

FIG. 58 is a schematic constitutional diagram showing beam positioning in an optical recording and reproduction method according to an embodiment of this invention;

FIG. 59 is a diagram schematically showing an example of pits and recording and reproduction signals;

FIG. 60 is a diagram schematically showing an example of pits and recording and reproduction signals;

FIG. 61 is a diagram schematically showing an example of pits and recording and reproduction signals;

FIG. 62 is a diagram schematically showing an example of pits and recording and reproduction signals;

FIG. 63 is a diagram schematically showing an example of pits and recording and reproduction signals;

FIG. 64 is a schematic constitutional diagram showing a relevant part of an example of an optical pickup device;

FIG. 65 is a schematic constitutional diagram showing a relevant part of an example of an optical pickup device;

FIG. 66A is a schematic side view showing an example of a solid immersion lens;

FIG. 66B is a schematic plan view showing an example of a solid immersion lens;

FIG. 67A is a schematic side view showing an example of a solid immersion lens;

FIG. 67B is a schematic plan view showing an example of a solid immersion lens;

FIG. 68 is a schematic sectional and constitutional diagram showing the tip portion of a solid immersion lens;

FIG. 69A is a schematic side view showing an example of a solid immersion lens;

FIG. 69B is a schematic plan view showing an example of a solid immersion lens;

FIG. 70 is a schematic sectional and constitutional diagram showing the tip portion of a solid immersion lens;

FIG. 71 is a schematic constitutional diagram showing beam positioning in an optical recording and reproduction method according to an embodiment of this invention;

FIG. 72 is a schematic perspective diagram showing a relevant part of an example of an optical recording medium;

FIG. 73 is a schematic sectional diagram showing a relevant part of an example of an optical recording medium; and

FIG. 74 is a schematic constitutional diagram showing beam positioning in an optical recording and reproduction method according to an embodiment of this invention.

### DESCRIPTION OF THE PREFERRED EMBODIMENTS

Hereinafter, an optical recording and reproduction method, optical pickup device, optical recording and reproduction device, optical recording medium and manufacturing method therefor, and semiconductor laser device according to embodiments of this invention are explained, referring to the drawings. However, this invention is not limited to the examples explained below.

As schematically shown in FIG. 1 in the configuration of a relevant part of an optical pickup device according to an embodiment of this invention, near-field light irradiation mechanism 2 including, for example, a solid immersion lens (SIL), positioned in proximity to the surface of an optical recording medium 1 in a state of optical contact, and an optical lens 3, are positioned in order to form a focusing lens. This configuration can be applied to an optical recording and reproduction device including an optical recording medium and an optical pickup device which adopt a so-called near-field optical recording and reproduction method.

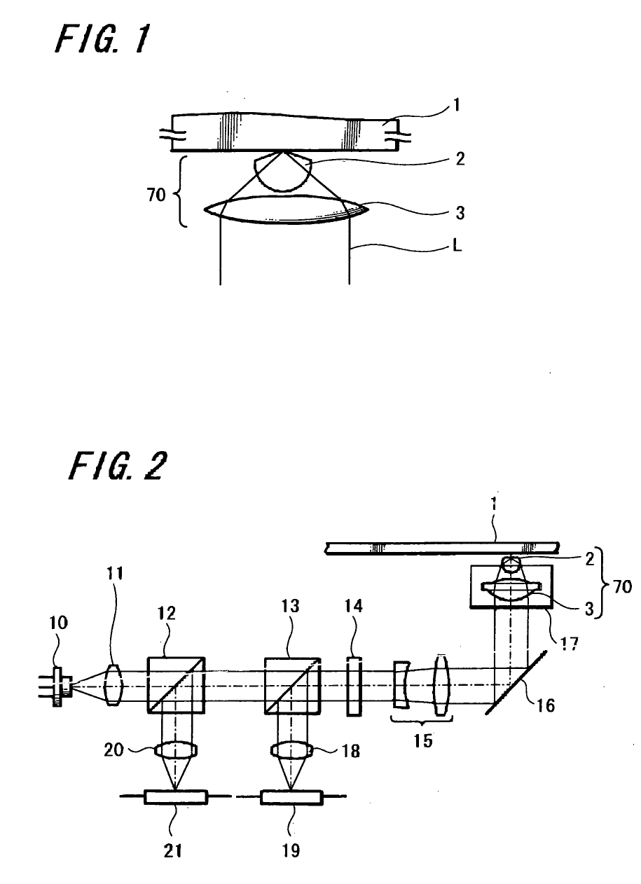

FIG. 2 schematically shows the configuration of an optical pickup device according to an embodiment of this invention. A plurality of light beams irradiated from a light source 10 (in the drawing, only a single representative optical path is shown) are rendered parallel by a collimating lens 11, pass through a non-polarizing beam splitter 12 and polarizing beam splitter 13, and after passing through a quarter-wavelength plate 14, the beam width is adjusted by a beam expander 15; the beams are then, for example, reflected by a mirror 16 and are incident on a focusing lens mounted on an actuator 17, that is, an optical lens 3 and near-field light irradiation mechanism 2 such as a SIL, to irradiate the optical recording medium 1 as near-field light.

Light reflected from the recording surface of the optical recording medium 1 passes through the near-field light irradiation mechanism 2 and optical lens 3, is reflected by the mirror 16, passes through the beam expander 15 and quarter-wavelength plate 14, is partly reflected by the polarizing beam splitter 13 to be focused on first photo-receiving mechanism 19 by the lens 18. The portion of light which passes through the polarizing beam splitter (PBS) 13 is reflected by the non-polarizing beam splitter (NPBS) 12 and is focused on second photo-receiving mechanism 21 to be detected by the lens 20. A configuration is possible in which the light reflected from the polarizing beam splitter 13 and received by the first photo-receiving mechanism 19 is, for example, used to form a tracking signal and RF reproduction signal, and light received by the second photo-receiving mechanism 21 is, for example, used to reproduce a gap detection signal to control the interval between the near-field light irradiation mechanism and the optical recording medium. As the first photo-receiving mechanism 19 for recording and reproduction, a photodetector having two or more photo-receiving portions corresponding to the number of beams is used; similarly in cases in which there are two or more gap detection beam spots.

In this example, a case is described in which gap detection is performed using changes in polarization. That is, when the gap between the optical recording medium and the near-field light irradiation mechanism, such as an SIL, is large, and light undergoes approximately total reflection at the SIL and surface, the polarization changes on the SIL surface, and so a portion of the light leaks from the PBS 13 on the return light path. If on the other hand the optical recording medium and SIL are in close proximity, and near-field light leaks so that reflection is nearly normal, there is little change in the polarization, and so the amount of light leaking from the PBS 13 is small. This difference, that is, the change in the amount of total-reflection return light, can be utilized for gap detection.

In addition, various other methods of gap detection, such as, for example, methods in which electrostatic capacitance changes are detected, can be adopted.

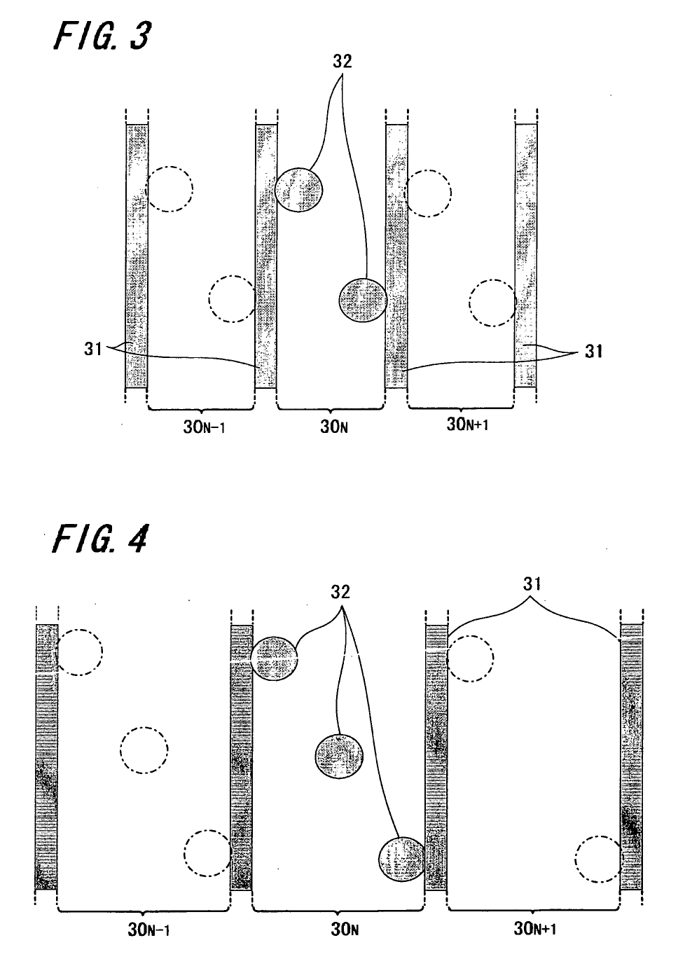

FIG. 3 schematically shows a plan view of a state in which a plurality of beam spots for recording and reproduction are made to irradiate the optical recording medium by an optical pickup device with the above configuration. A guide track 31 with a groove or land shape, or including pits or wobbles, described later on, is formed on the optical recording medium 1 in, for example, a single spiral shape. In this example, two beam spots 32 are shown irradiating a recording and reproduction area 30N between the guide tracks 31. “30N−1” and “30N+1” respectively denote recording and reproduction areas one circumference before and after the area 30N; here, beam spot positions are shown schematically by dot-dash lines.

By means of such a configuration, two recording tracks are provided in one recording and reproduction area for recording and/or reproduction, and the transfer rate can be increased twofold, without increasing the rate of rotation of the optical recording medium compared with the related art.

In this case, at least one among these beam spots 32, or both the beam spots, can be used to perform gap detection simultaneously with recording or reproduction, and by this means the stability of near-field recording and reproduction can be improved.

If a double-spiral shape is used for the guide track, then recording and/or reproduction is performed with the group of beam spots proceeding along every other recording and reproduction area; by irradiating the adjacent recording and reproduction areas with a plurality of beam spots to perform recording and/or reproduction, a still greater increase in the transfer rate is possible.

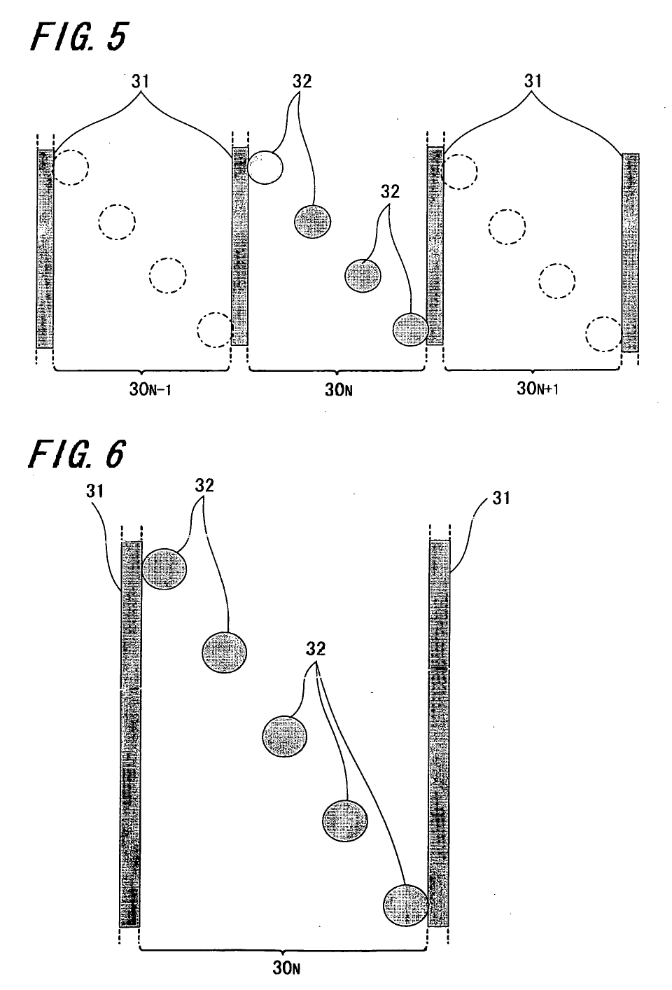

In this invention, as shown in FIGS. 4 through 6, from three to five recording and reproduction beam spots 32 may be positioned between the guide tracks 31. In such cases, individual beam spots 32 are positioned at approximately equal intervals in the direction of the width of the guide tracks 31, that is, in the radial direction when using a disc-shaped optical recording medium, and are also positioned at approximately equal intervals in the length direction of the guide tracks 31, that is, in the tangential direction; consequently, crosstalk and intersymbol interference can be suppressed. In FIGS. 4 through 6, portions corresponding to those in FIG. 3 are assigned the same symbols, and redundant explanations are omitted.

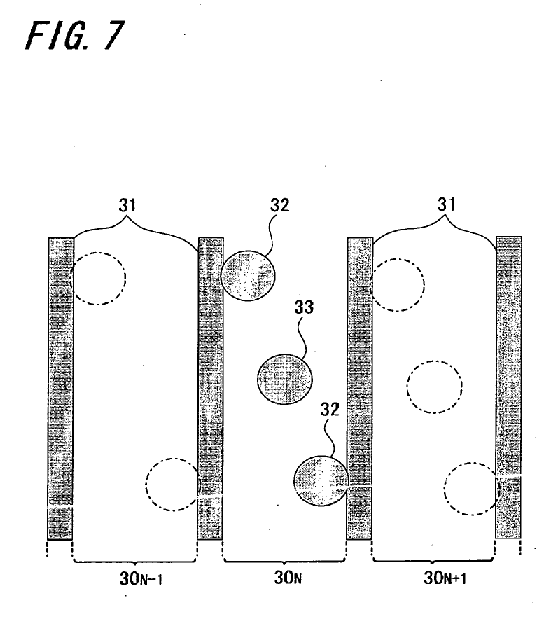

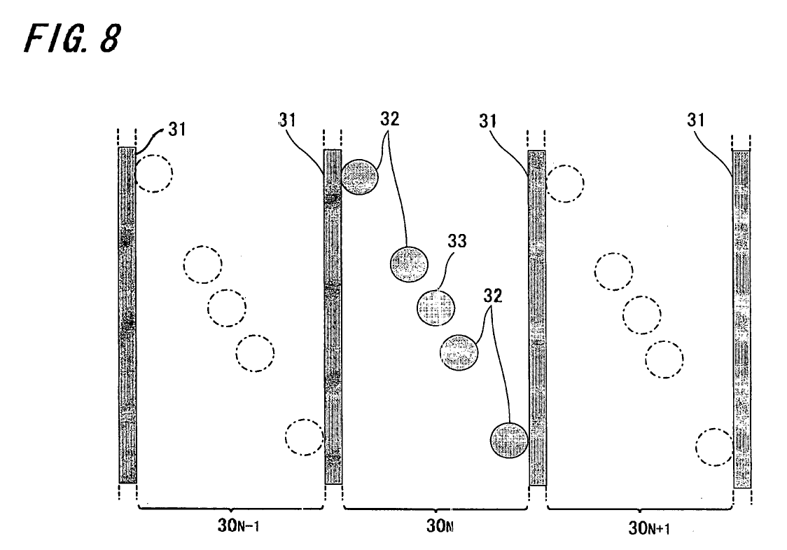

As indicated in FIGS. 7 and 8, in this invention a configuration can be adopted in which a gap detection beam spot 33 is provided in, for example, approximately the center position in the width direction (radial direction) of the guide track 31, separately from the recording and reproduction beam spots 32. By providing such a gap detection dedicated beam spot 33, fluctuations in the gap detection signal due to changes in the amount of light caused by the presence or absence of recording light pulses during recording in particular can be avoided, and because the gap detection signal is extremely stable, more accurate gap control is possible.

By thus providing a gap detection beam spot 33 at approximately the center position of the recording and reproduction area 30, the gap can be detected accurately without a bias toward one edge of the position irradiated by the spot. In FIGS. 7 and 8, portions corresponding to those in FIG. 3 are assigned the same symbols, and redundant explanations are omitted.

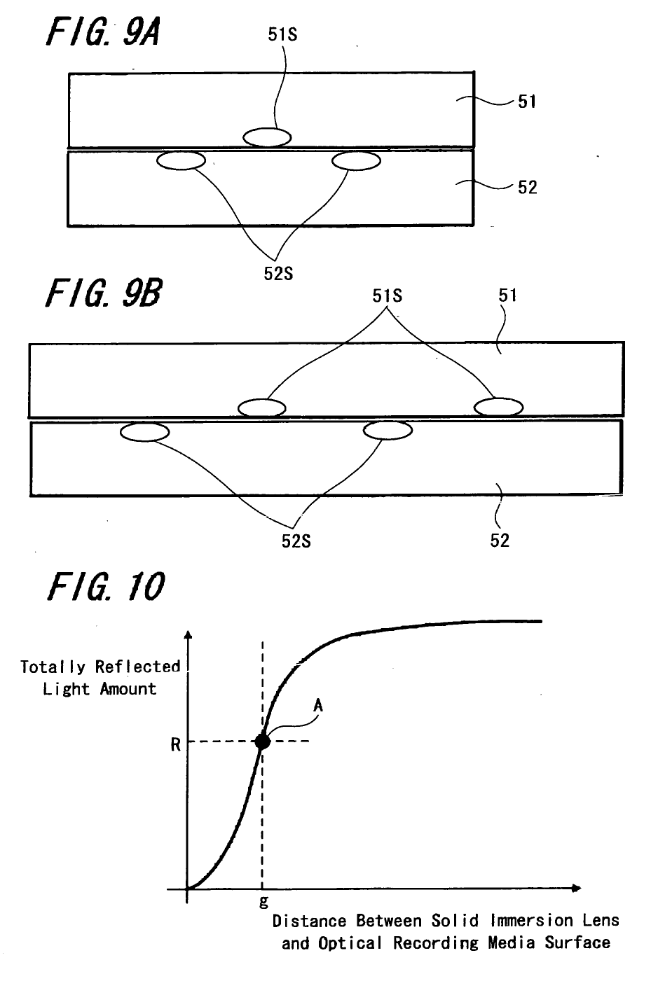

FIGS. 9A and 9B schematically show the configurations of examples of semiconductor laser devices used as light sources for such a plurality of beams. In FIG. 9A, an example is shown of an odd number of beams, such as three; in this case, the semiconductor laser device is constructed by stacking, for example, a semiconductor laser 51 having a single emission surface 51S, and a semiconductor laser 52 having two emission surfaces 52S, with the emission surfaces in proximity.

In FIG. 9B, an example is shown of an even number of beams emitted (four in the example of the drawing); semiconductor lasers 51 and 52, each having two emission surfaces 51S, 52S, are stacked with the emission surfaces in proximity to form the semiconductor laser device.

In each of these examples, it is desirable that the intervals between the emission surfaces 51S, 52S be approximately equal; by positioning the beam spots such that intervals therebetween are approximately equal, crosstalk and intersymbol interference can be suppressed, as explained above. For example, in the example of FIG. 9B, by making adjustments such that the intervals between the emission surfaces of elements are approximately equal and one emission surface of another semiconductor laser element is positioned in the center position, beam spots can be obtained with one-half the interval of the emission surface intervals of each of the semiconductor laser elements.

When irradiating positions within the same recording and reproduction area with such recording and reproduction beam spots and gap detection beam spots, because the interval (gap) between the near-field light irradiation mechanism and the optical recording medium is approximately the same at the irradiation positions of the recording and reproduction beam spots and the gap detection beam spots, it is possible to determine the gap g at recording and reproduction beam spot irradiation positions unambiguously from, for example, the amount R of totally reflected return light of the gap detection beam spot A, as shown in the example of FIG. 10.

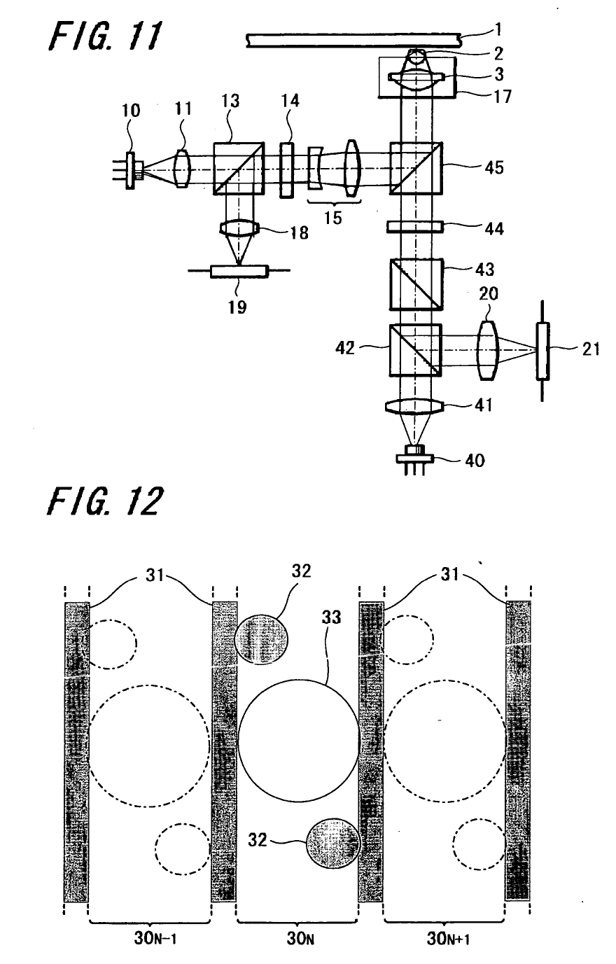

FIG. 11 schematically shows an example of the configuration of an optical pickup device when using, as the gap detection beam spot, light at a different wavelength from the recording and reproduction beam spots. In FIG. 11, portions corresponding to those in FIG. 2 are assigned the same symbols, and redundant explanations are omitted. In this case, a light source 40 with wavelength different from that of light source 10 is used to irradiate the dichroic prism 45 via the collimating lens 41, beam splitter 42, polarizing beam splitter 43, and quarter-wavelength plate 44; in the dichroic prism 45, the light is combined with light from the light source 10, and the resultant light passes through the optical lens 3 and the near-field light irradiation mechanism 2, for example a SIL, to irradiate the optical recording medium 1 as recording and reproduction beam spots and gap detection beam spots. Similarly to the example explained using FIG. 2, the portion of return light from the optical recording medium 1 due to the gap detection beam spot which leaks from the polarizing beam splitter 43 is reflected by the beam splitter 42 and passes through the lens 20 to be detected by the second photo-receiving mechanism 21, and as a result gap control can be performed.

FIG. 12 schematically shows a plan view of an example of a state in which, using an optical pickup device configured in this way, an optical recording medium 1 is irradiated with beam spots. By using light of, for example, wavelength 405 nm as the recording and reproduction beam spots 32 and light of, for example, wavelength 680 nm as the gap detection beam spot 33, a comparatively broad area can be irradiated with the gap detection beam spot 33 within the recording and reproduction area.

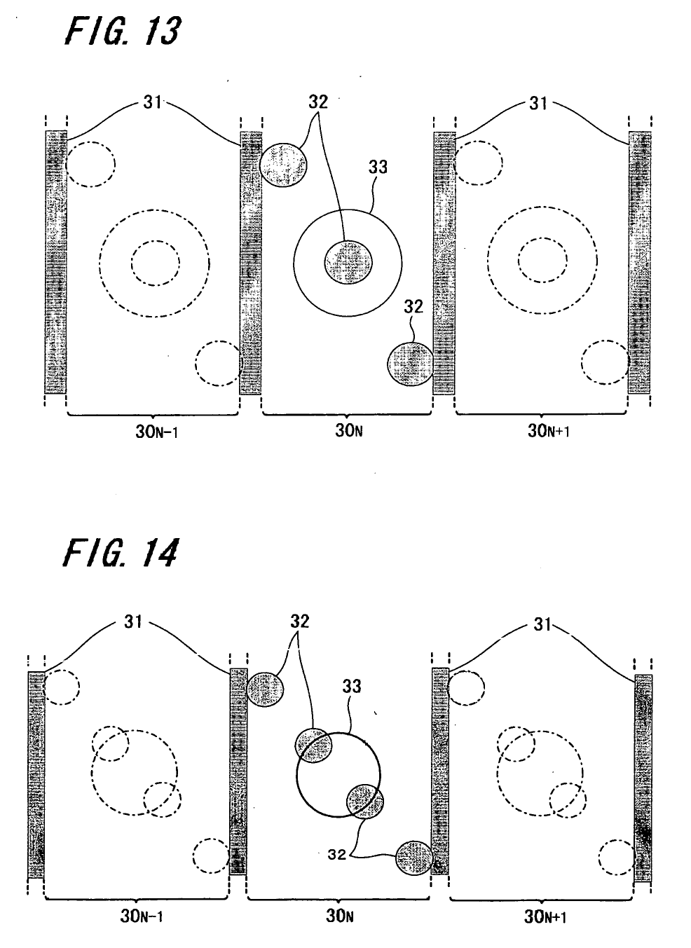

FIG. 13 shows a case in which there are three recording and reproduction beam spots 32, and a gap detection beam spot 33 overlaps with the center beam spot.

FIG. 14 shows a case in which there are four recording and reproduction beam spots 32, and a gap detection beam spot 33 partly overlaps with the two inner beam spots.

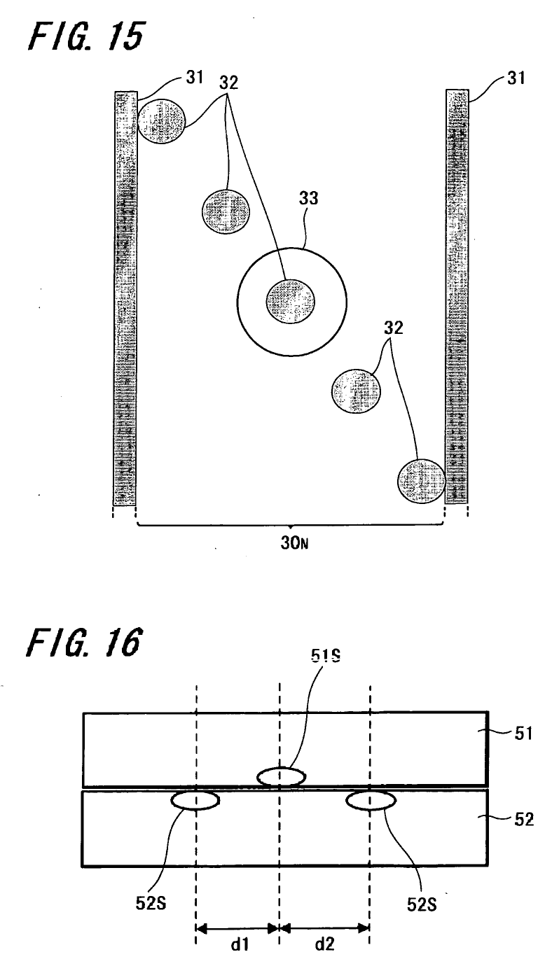

FIG. 15 shows a case in which five recording and reproduction beam spots 32 are used, and the gap detection beam spot 33 overlaps with the center beam spot.

In FIGS. 12 through 15, portions corresponding to those in FIG. 3 are assigned the same symbols, and redundant explanations are omitted.

When the wavelength of the gap detection beam spot is made different from the wavelength of the recording and reproduction beam spots, a semiconductor laser device including semiconductor lasers 51 and 52 with different oscillation wavelengths in a stacked structure can be used, as schematically shown in the example of a configuration of FIG. 16. In this case also, by making the intervals d1, d2 between the emission surfaces 51S, 52S approximately equal, the gap detection beam spot 33 can be positioned at the center position between the recording and reproduction beam spots 32, so that more accurate gap detection can be performed.

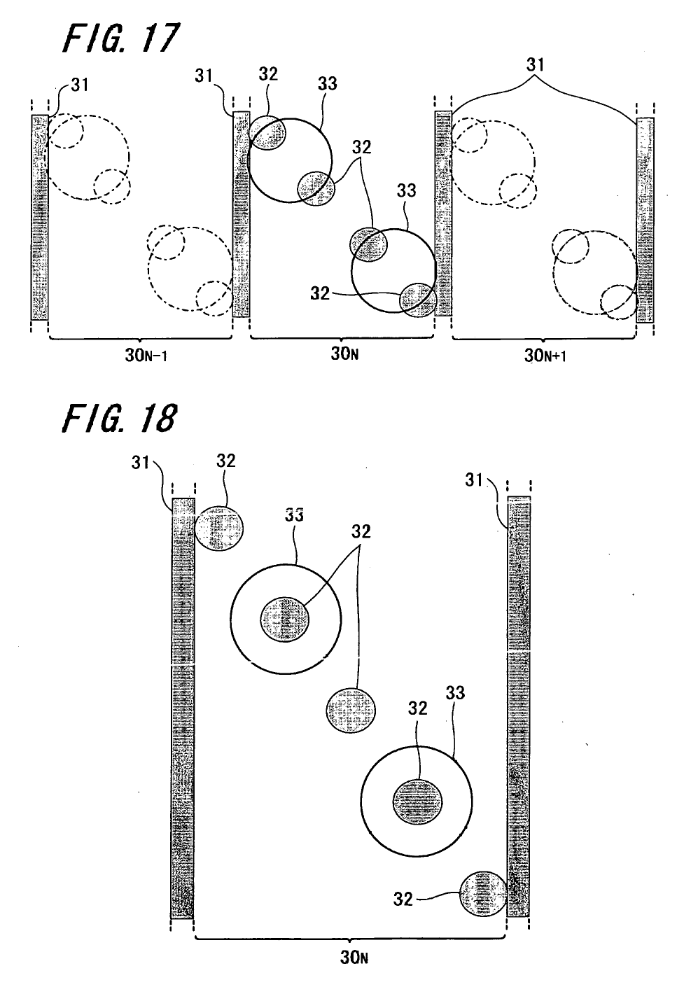

On the other hand, two or more gap detection beam spots can be provided; examples are shown in FIGS. 17 and 18. In FIGS. 17 and 18, portions corresponding to those in FIG. 3 are assigned the same symbols, and redundant explanations are omitted.

As an optical pickup device which irradiates the optical recording medium with such beam spots, in the optical pickup device explained above using FIG. 11, a configuration can be employed in which the light source 40 is used for multiple beam emission, and the photo-receiving element 20 is a photodetector having a plurality of photo-receiving portions.

By thus adopting a configuration in which the recording and reproduction area is irradiated with gap detection beam spots at a plurality of positions, and particularly when irradiating with three or a greater number of recording and reproduction beam spots, gap control in the vicinity of each spot can be performed reliably and accurately.

Further, the amount of return light from a plurality of gap detection beam spots can be utilized to detect the inclination toward the surface of the optical recording medium of the near-field light irradiation mechanism, such as, for example the end face of a SIL, and by using this result to perform tilt control, more stable recording and reproduction become possible.

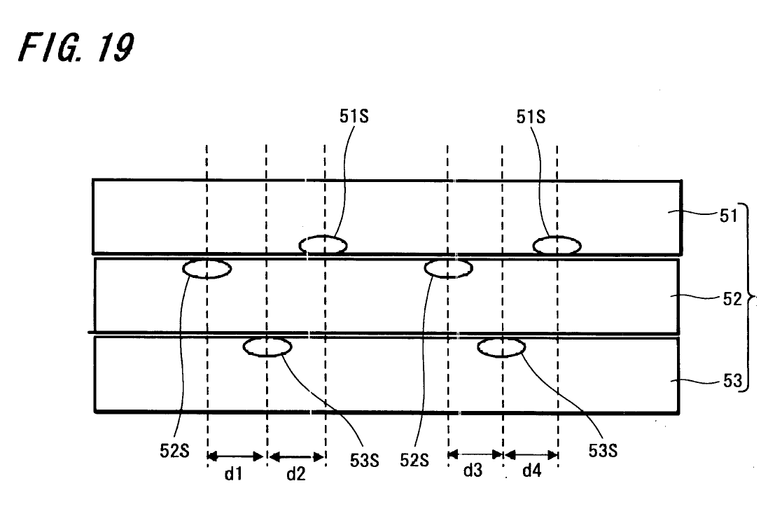

FIG. 19 schematically shows an example of a semiconductor laser device which can be used when irradiating the optical recording medium with a plurality of recording and reproduction beam spots and a plurality of gap detection beam spots. The semiconductor lasers 51 and 52 are used for recording and reproduction and have the same wavelength; the semiconductor laser 53 is a light source for gap detection, and emits light at a comparatively long wavelength, for example. A case is shown in which the laser elements 51 to 53 are arranged such that the two emission surfaces 51S, 52S of the semiconductor lasers 51, 52 are positioned at approximately equal intervals, and the emission surface 53S of the semiconductor laser 53 is, for example, positioned between the other emission surfaces 51S, 52S, that is, such that the intervals d1 to d4 from the emission surfaces 53S to the emission surfaces 51S, 52S are approximately equal in the direction perpendicular to the stacking direction of the semiconductor lasers 51 to 53. By means of this configuration, the recording and reproduction beam spots are positioned at approximately equal intervals within the recording and reproduction area, and the gap detection beam spots can be positioned at positions approximately symmetrical about the center position.

Thus even when using light of wavelength different from that of recording and reproduction beam spots as the gap detection beam spot, the interval between the near-field light irradiation mechanism and the optical recording medium can easily be determined from the relation between the amount of totally reflected light and the gap, as explained in FIG. 10. Even if the wavelengths are different, the height above the optical recording medium surface of the position irradiated by the spots is the same, and so the gap amount detected using the gap detection spot can be used without modification to adjust the recording and reproduction beam spots.

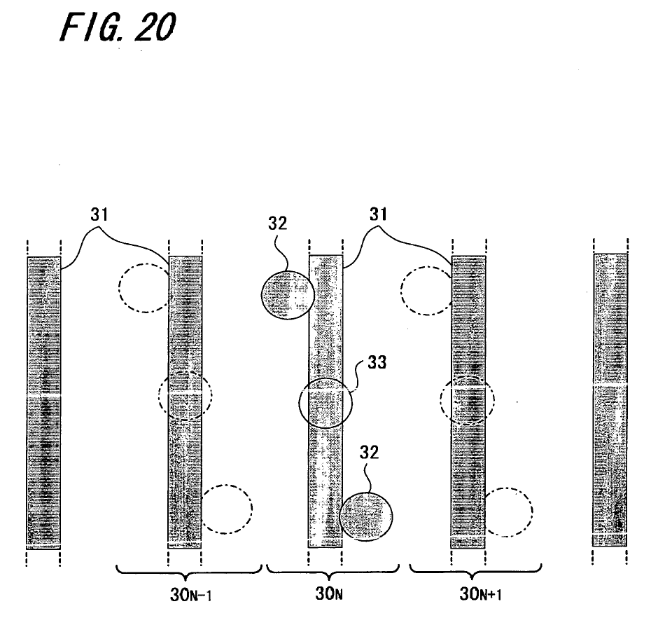

Next, another embodiment of an optical recording and reproduction method of this invention is explained. In this example, as shown in the schematic configuration example of FIG. 20, two or more recording and reproduction beam spots are positioned in the recording and reproduction areas on both sides of a guide track on the optical recording medium to perform recording and/or reproduction, and in addition a gap detection beam spot to detect the interval between the near-field light irradiation mechanism and the surface of the optical recording medium is positioned on the guide track.

In the example shown in FIG. 20, two recording and reproduction beam spots 32 are positioned on either side of the guide track 31 of the optical recording medium, and the gap detection beam spot 33 is positioned approximately at the center position.

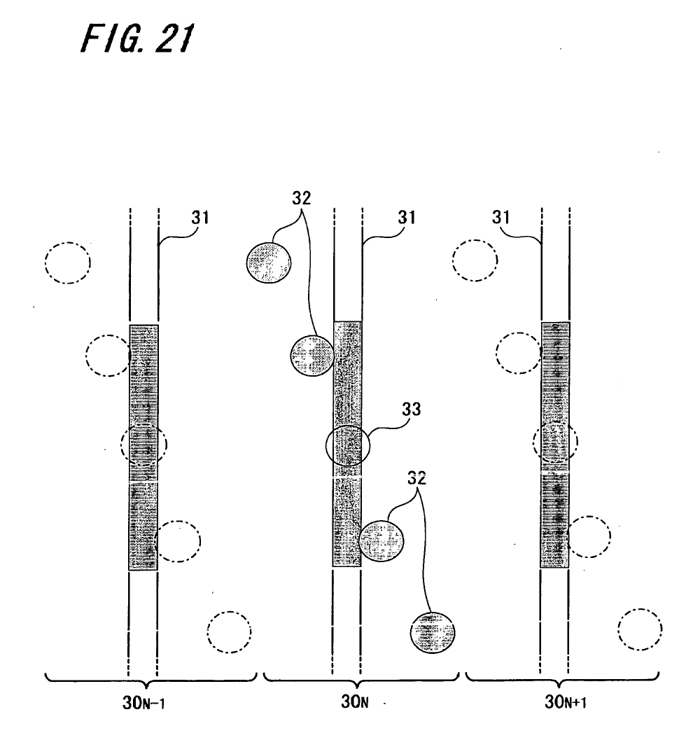

FIG. 21 shows a case in which five beam spots are used; the beam spots are positioned at approximately equal intervals, and the gap detection beam spot 33 is positioned in the center position. In FIGS. 20 and 21, portions corresponding to those in FIG. 3 are assigned the same symbols, and redundant explanations are omitted. Here, the case of recording tracks with a single spiral shape is shown, but a double spiral shape may be used as well, similarly to the example described above.

When the gap detection beam spot 33 is positioned on the guide track 31, the heights on the surface of the optical recording medium of the positions irradiated by the recording and reproduction area beam spots 32 and by the gap detection beam spot 33 are different.

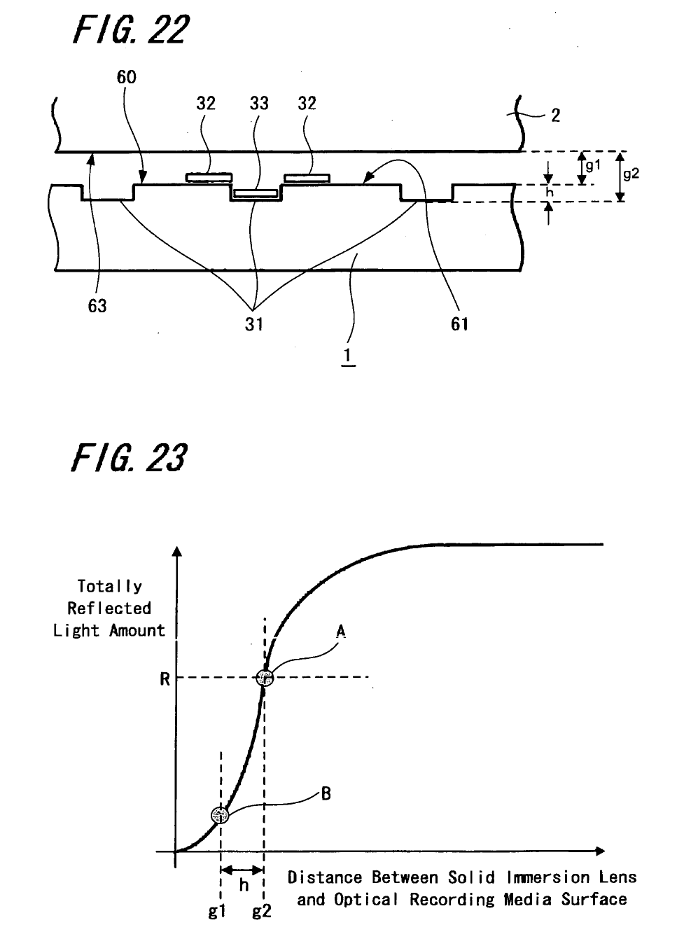

For example, as shown in the enlarged sectional view of a relevant part in an example of an optical recording medium in FIG. 22, when the guide track 31 is, for example, groove-shaped, and the depth from the medium surface 60 is h, the interval between the end surface of the near-field light irradiation mechanism 2 and the medium surface 60, that is, the recording surface 61, is g1 at the positions of irradiation of the recording and reproduction beam spots 32, but is g2 at the position of irradiation of the gap detection beam spot 33 on the guide track 31, and the difference therebetween is h.

In this case, as indicated by the relation in FIG. 23 between the amount of totally reflected return light and the gap between the optical recording medium surface and the near-field light irradiation mechanism, for the gap g2 detected by the gap detection beam spot (A), if the gap corresponding to totally-reflected return light amount R is g2, then the gap g1 at the irradiation position of the spot (B) for recording and reproduction is g2−h.

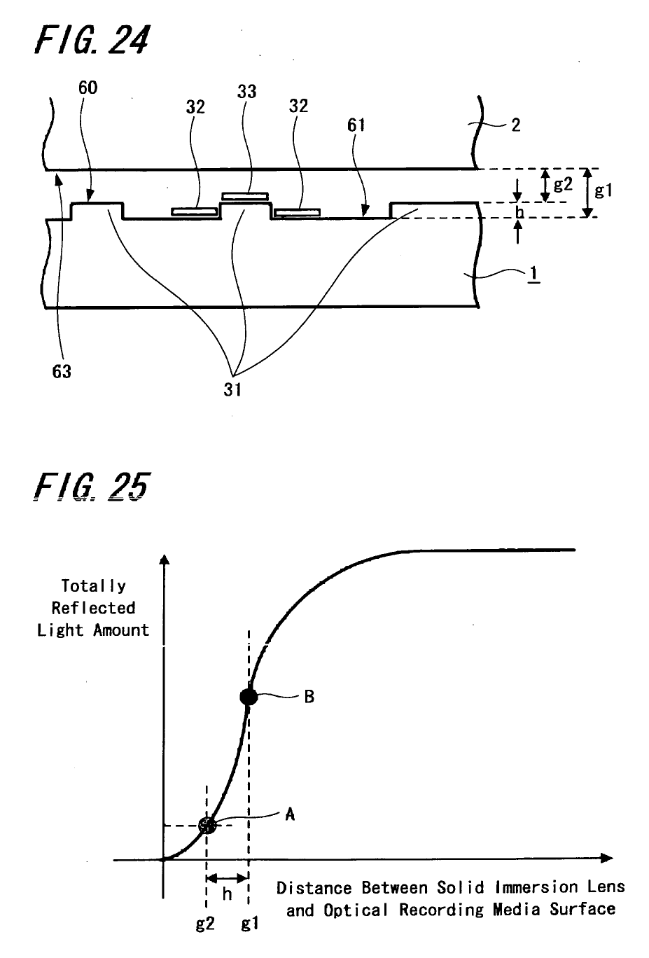

On the other hand, when the guide track 31 has a land shape as shown in FIG. 24, the position irradiated by recording and reproduction beam spots 32 is more distant, by the distance h, from the near-field light irradiation mechanism 2 than is the position irradiated by the gap detection beam spot 33. Hence in this case, as indicated by the relation in FIG. 25 between the gap and the totally reflected return light amount, for a gap g2 detected by the gap detection beam spot (A), the gap g1 at the positions irradiated by recording and reproduction beam spots (B) is given by g2+h.

Thus even in cases where the gap detection beam spot is positioned on a guide track, it is possible to easily and reliably detect the interval between the near-field light irradiation mechanism and the surface of the optical recording medium at the positions irradiated by recording and reproduction beam spots.

As explained above, when positioning recording and reproduction beam spots and gap detection beam spots in a recording and reproduction area between guide tracks, because the gap is approximately equal, gap detection errors due to dispersion in the guide track height (or depth) can be suppressed, with the advantageous result that more accurate gap detection is possible.

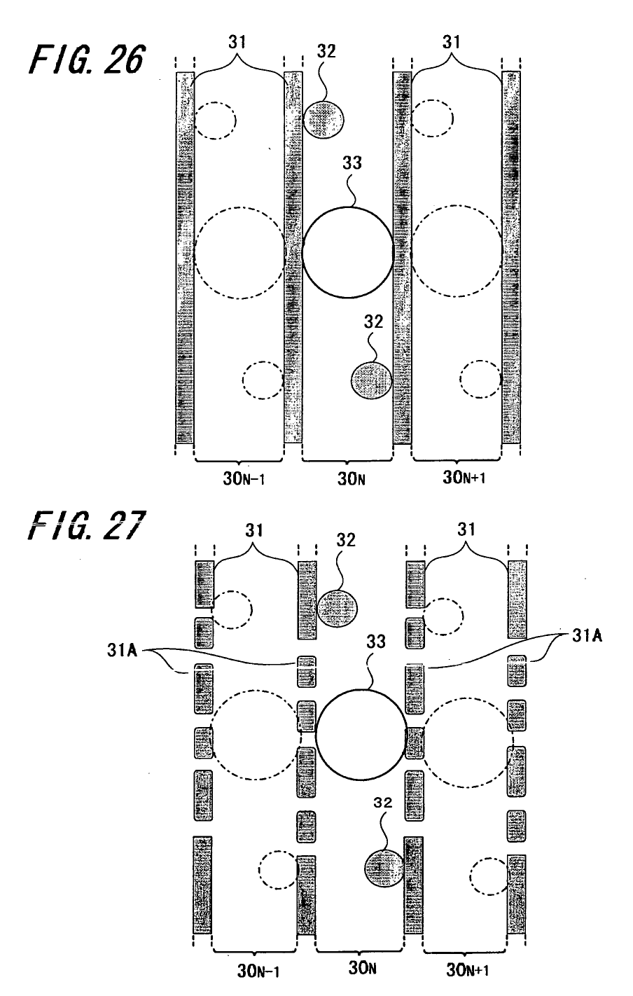

The above-described beam spot positioning does not impose limits on the shape of guide tracks. For example, application is not limited to cases in which the shape of the guide track 31 is a straight groove (concave shapes) or a land (convex shapes) as indicated in FIG. 26; as shown schematically in FIG. 27, pits 31A can be provided on a guide track 31, or pits 31A can be provided on a guide track 31 after each circumference as shown in FIG. 28, that is, pits 31A can be provided only on one side of the two sides of the recording and reproduction area, or pits 31A can be provided intermittently, as indicated in FIG. 29.

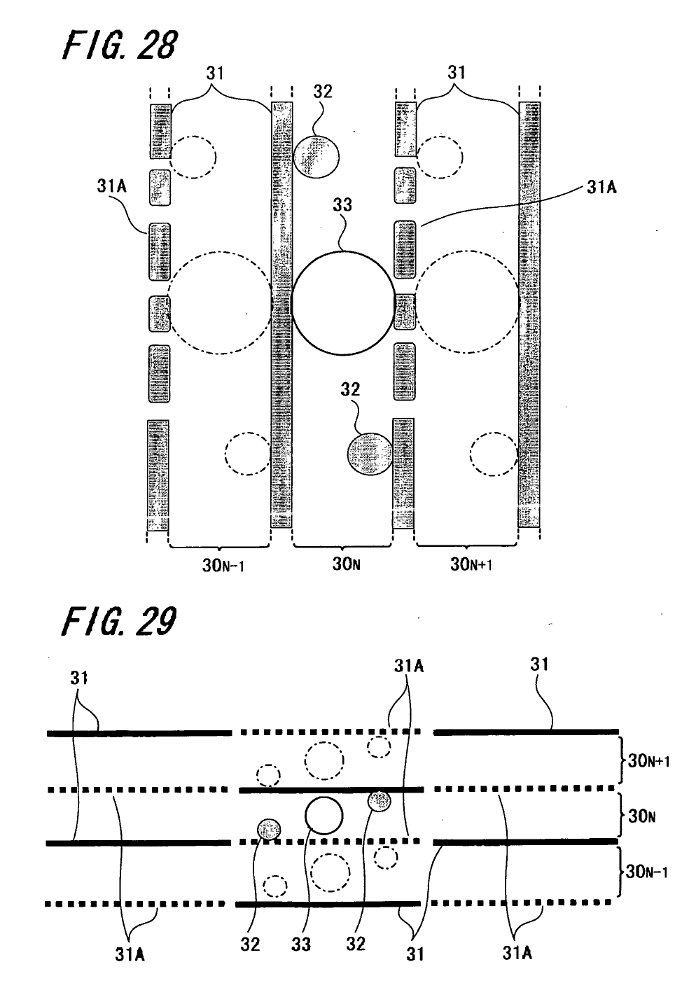

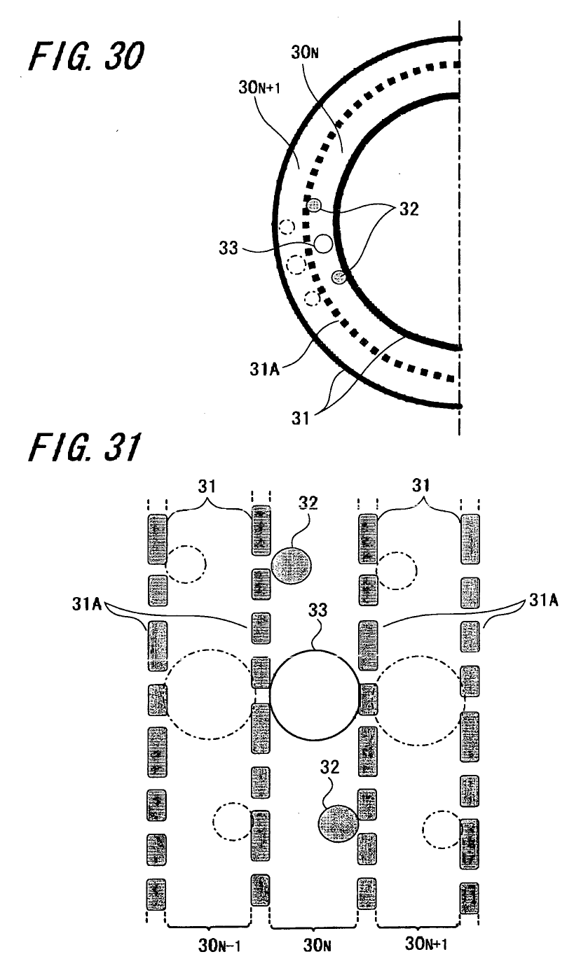

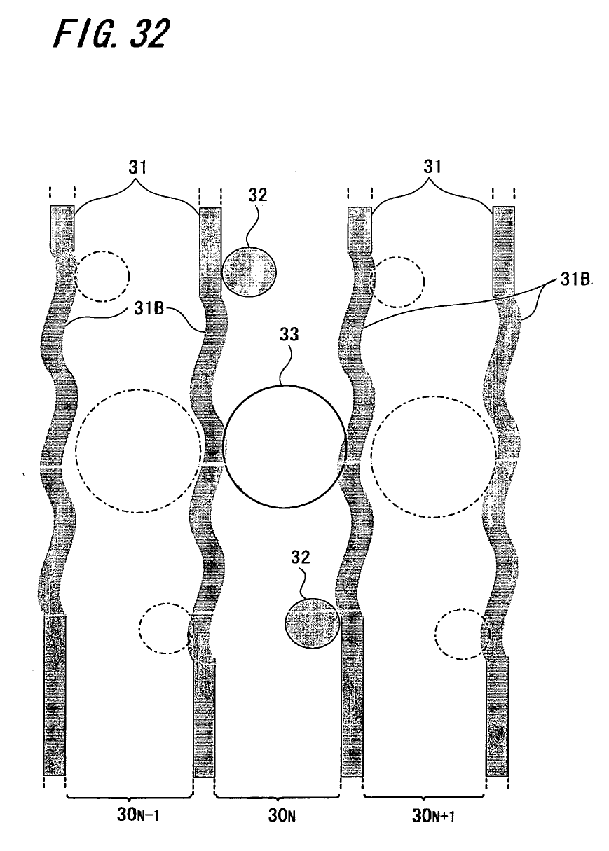

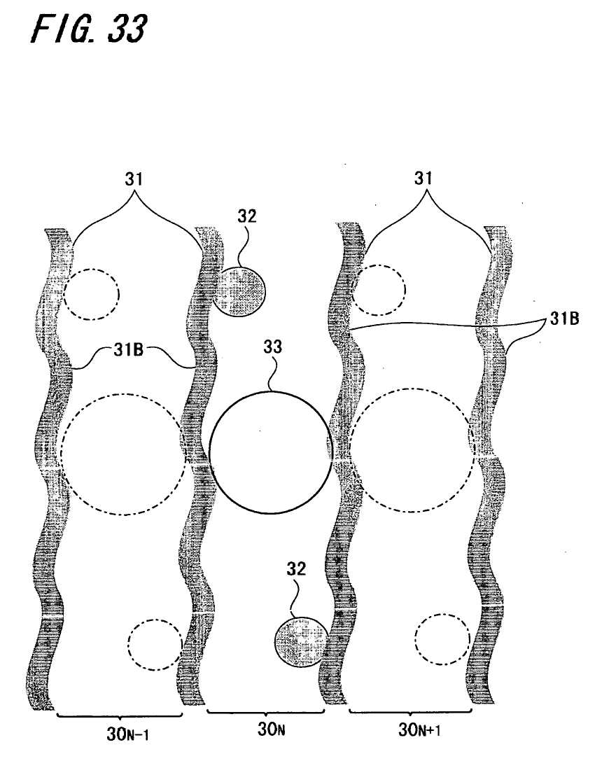

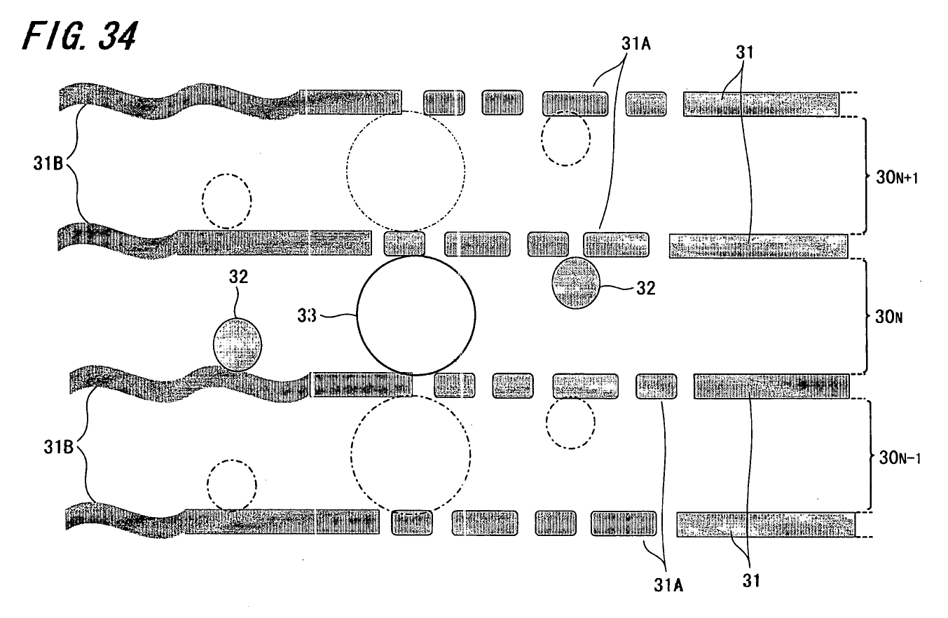

As shown in FIG. 30, cases in which grooves or lands and pits are provided intermittently every half-circumference are similar; and cases such as FIG. 31, where pits 31A are provided continuously on a guide track 31, cases such as FIG. 32, where wobbles 31B are provided on a portion of the guide track 31, cases such as FIG. 33, where wobbles 31B are provide over approximately the entirety of the guide track 31, and cases such as FIG. 34, where pits 31A and wobbles 31B are provided locally, coexisting on groove- or land-shaped guide tracks 31, are also similar.

In FIGS. 26 to 35, portions corresponding to those in FIG. 12 are assigned the same symbols, and redundant explanations are omitted. In each of the above drawings, examples are shown in which two beam spots 32 are provided for recording and reproduction, and a gap detection beam spot 33 is provided approximately in the center position therebetween; but the positioning of beam spots is not limited to these examples, and of course there are similarly no limitations on the number of beams, or in cases where the gap detection beam spot or spots are positioned within the recording and reproduction area or are positioned on a guide track.

In all of these cases, as explained above, even when pits or wobbles are provided locally or continuously, gap detection can be performed accurately, and the stability of near-field recording and reproduction can be improved.

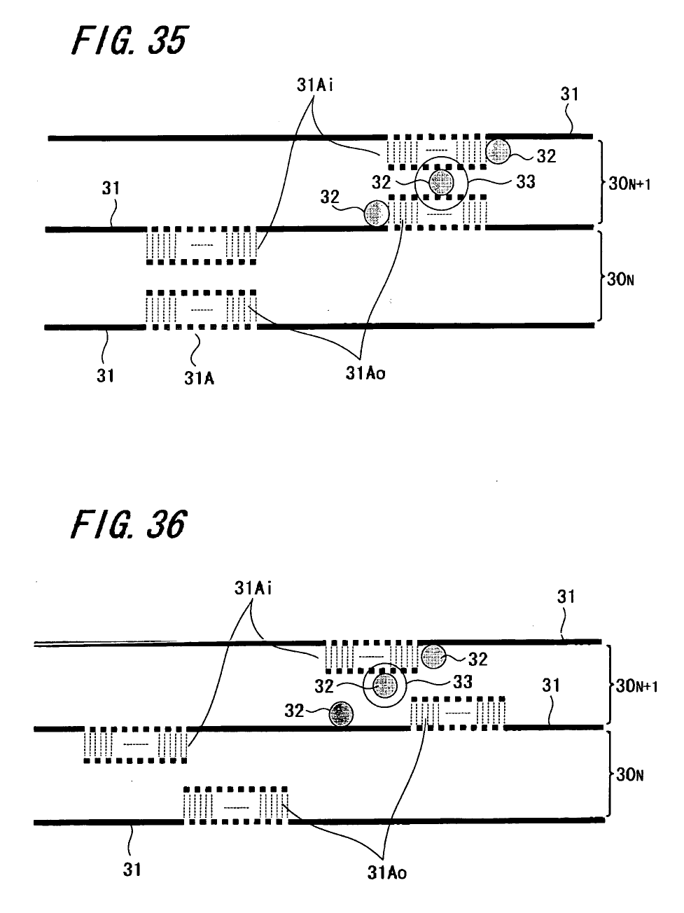

Next, FIGS. 35 through 38 are used to explain cases in which a pit-shaped track is formed on the inside of the guide track, by forming at least a portion as a guide track, pits or wobbles using a high-speed blanking method in an electron lithography system, in order to more reliably perform tracking of recording marks for recording and/or reproduction in the area on the inside of the guide track.

In FIG. 35, when providing a high-speed blanking portion in a portion of the guide track 31, at the time of fabricating the optical recording medium a pattern corresponding to the guide track is formed in the master using an electron lithography system by electron beam recording or so-called cutting; by means of high-speed blanking with oscillations in portions to, for example, the inside or the outside, a pit-shape guide track pattern is formed in the inside area of the recording and reproduction area 30. When an optical recording medium is manufactured from a master fabricated through such optical recording, as indicated in FIG. 35, high-speed blanking portions 31Ai, 31Ao are formed, as pit-shaped tracks, on the inside or on the outside of the guide track 31 as partly intermittent patterns. By appropriately setting the amplitude of the high-speed blanking, high-speed blanking portions 31Ai or 31Ao are positioned on both sides of the beam spots 32 irradiating the recording and reproduction area, as in the example of the drawing; as a result satisfactory tracking can be performed, and more stable recording and reproduction becomes possible. In addition, pits can be formed for beam spots in the center portion of the guide track.

The example of FIG. 35 is a case in which high-speed blanking portions 31Ai and high-speed blanking portions 31Ao are formed on the inside and on the outside respectively, synchronously between adjacent guide tracks; however, as shown in FIG. 36, a configuration can also be adopted in which the high-speed blanking formation positions on the inside and on the outside are not synchronized, but are shifted in the radial direction. When a near-field recording and reproduction method is to be used to raise the recording density, with the guide track width reduced to several hundred nanometers or less, if pit-shape patterns are too close due to high-speed blanking, when the optical recording medium substrate is formed by, for example, injection molding there is the possibility that this shape may be deformed. But when the blanking positions of oscillations are shifted in the radial direction, the fine pit-shape patterns are appropriately isolated, and so satisfactory patterns can be maintained.

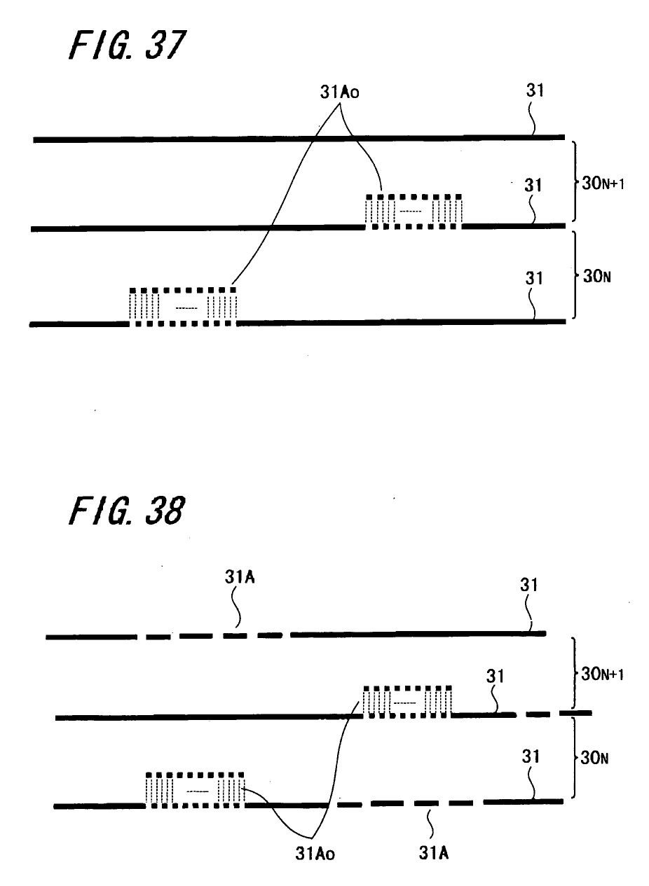

Further, high-speed blanking portions may be provided only on the outside or on the inside, for example. FIG. 37 shows an example in which only outside high-speed blanking portions 31Ao are provided. Further, as shown in FIG. 38, pits 31A may be formed separately from high-speed blanking portions 31Ao, and application is of course also possible when wobbles, not shown, are formed. Thus by providing track marks only in portions, separately from the guide track 31, and by synchronizing a number of times over each revolution, more stable recording and reproduction are possible. Similar advantageous results can be obtained when using high-speed blanking to partly form pits or wobbles separate from guide tracks.

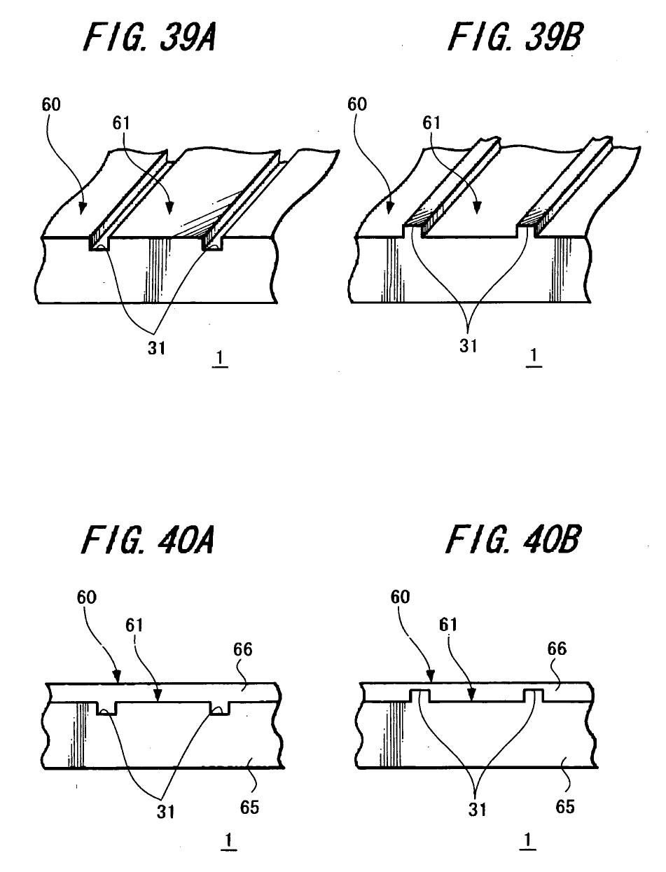

The above-described beam spot positioning configurations, configurations to provide high-speed blanking portions, and similar can be applied to various substrates and to an optical recording medium supporting various recording and reproduction methods. For example, this invention can be applied: to cases shown in FIG. 39A in which a guide track 31 of a concave shape, or a so-called guide groove, is provided in the medium surface 60 constituting the recording surface 61 of the optical medium 1; to cases shown in FIG. 39B in which the guide track 31 has a convex shape, that is, a land shape; and to cases shown in FIG. 40A and FIG. 40B respectively in which a planarizing layer 66 including a protective layer or similar which buries a concave-shape or convex-shape guide track 31 is provided.

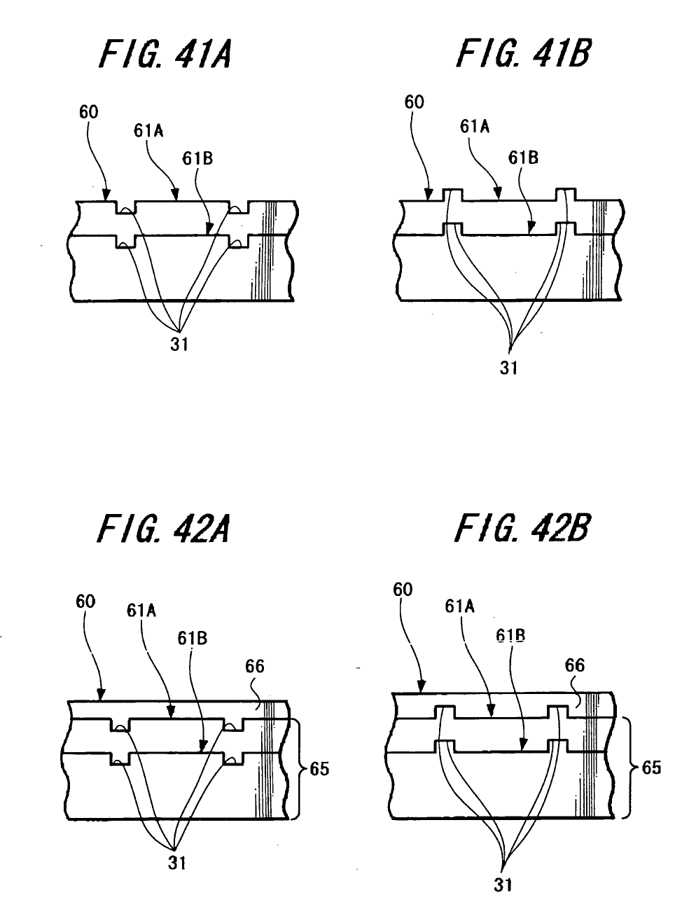

Application is similarly possible when the guide track 31 has a concave or a convex shape, and the recording surface has a two-layer configuration with first and second recording surfaces 61A and 61B provided, as shown in FIG. 41A and FIG. 41B, as well as when a planarizing layer 66 is provided on the second recording surface 61B on the surface side among the two surfaces of the recording layer.

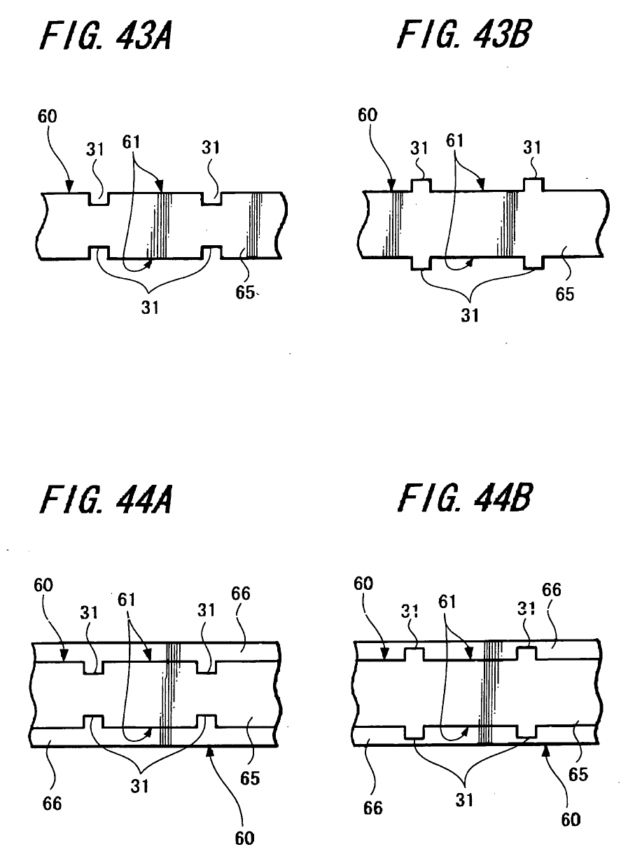

FIGS. 43 and 44 show cases in which guide tracks 31 and a recording surface 61 have been provided in the front surface and rear surface of the substrate 65; FIGS. 43A and 43B are cases in which the guide track 31 is formed in a concave and in a convex shape respectively, while FIGS. 44A and 44B are cases in which a planarizing layer 66 has been provided on the convex-shape or concave-shape guide track 31. An optical recording and reproduction method according to an embodiment of this invention can be applied to an optical recording medium with these various substrate shapes and recording surface configurations.

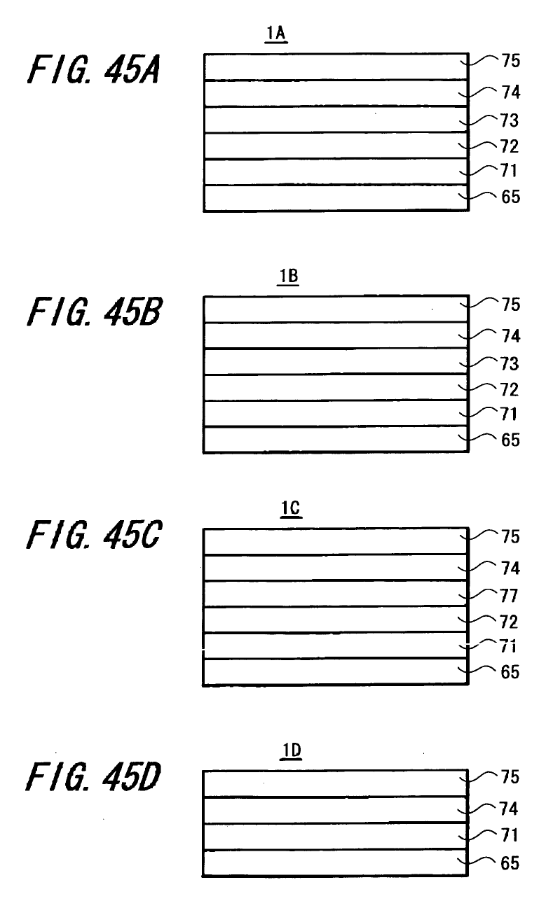

Similarly, the recording layer or recording and reproduction methods according to an embodiment of this invention can be applied to various optical recording media with sectional configurations schematically shown in FIGS. 45A through 45D. In FIG. 45A, an example of a phase-change recording medium 1A is shown; in this case, a reflecting layer 71, dielectric layer 72, phase-change material layer 73, dielectric layer 74, and protective layer 75 are provided on a substrate 70. FIG. 45B shows an example of a magneto-optical recording medium 1B; in this case, a reflecting layer 71, dielectric layer 72, magneto-optical recording layer 76, dielectric layer 74, and protective layer 75 are provided on a substrate 70. FIG. 45C shows an example of a dye recording medium 1C; in this case, a reflecting layer 71, dielectric layer 72, dye recording layer 77, dielectric layer 74, and protective layer 75 are provided on a substrate 70. FIG. 45D shows an example of a read-only medium 1D; so-called pits or recording marks which are a pattern of concave or convex pits, not shown, are formed in the substrate 70, on top of which are provided a reflecting layer 71, dielectric layer 74, and protective layer 75 to form the recording medium. By applying this invention to an optical recording media employing such various recording and reproduction methods, stable near-field recording and reproduction with a high transfer rate are possible.

Next, examples are explained in which, in an optical recording and reproduction method according to an embodiment of this invention, the starting interval distance of any one among guide tracks, pits, wobbles, or recording marks is used to calculate the beam position interval of two or more recording and reproduction beam spots. First, to facilitate understanding, an example is explained of calculating the beam position interval using the pit starting interval, for a case in which the recording and reproduction area is irradiated with two recording and reproduction beam spots. Note that the beam position interval can similarly be calculated using the starting interval when the guide track is intermittent, or using a wobble starting interval, or a recording mark starting interval, and calculations are not limited to pit starting intervals.

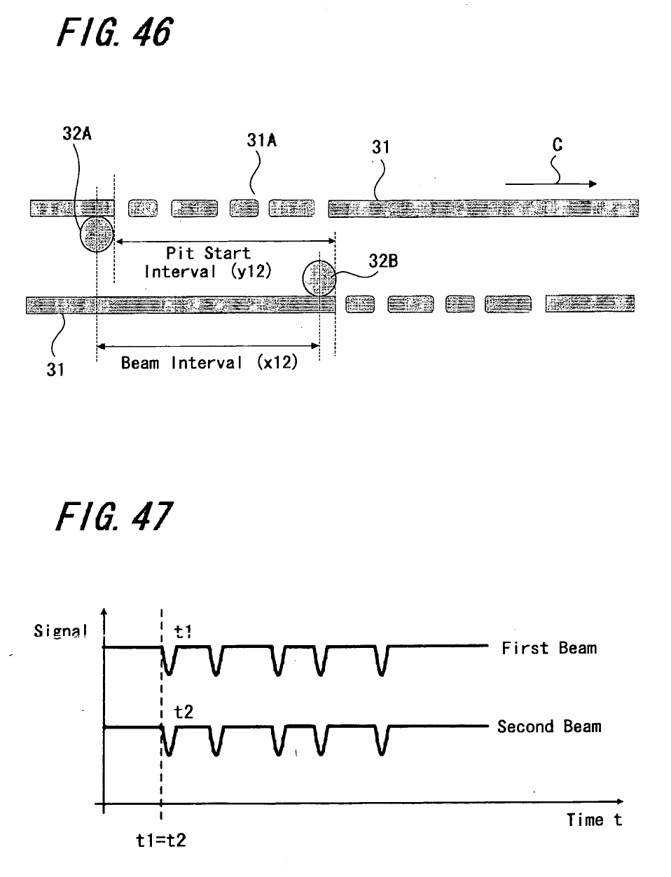

FIG. 46 schematically shows a configuration in which first and second beam spots 32A and 32B are positioned between guide tracks 31; the interval between these beams is x12, and the starting interval of pits formed in the optical recording medium is yl2. The arrow C indicates the direction of beam travel.

As shown in FIG. 46, when the beam interval x12 and pit starting interval yl2 are approximately equal, the pit reproduction signal for each beam as schematically shown in FIG. 47 is such that time start times t1 and t2 of the pit signals for the first and second beams are approximately simultaneous, so that the time difference Δt is approximately zero, and the beam position interval x12 is equal to the pit starting interval yl2.

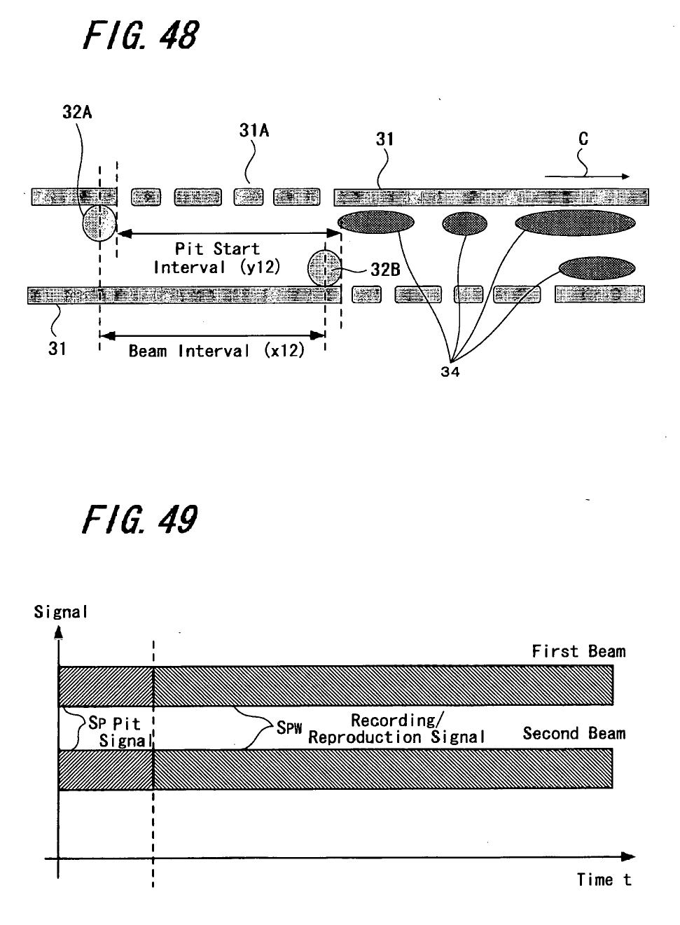

Hence as, for example, shown schematically in FIG. 48, by positioning the pits 31A on the guide track 31 at predetermined positions immediately before an area in which recording signals 34 are provided, pit signals SP are reproduced simultaneously by the first and second beams, as indicated schematically by the signal reproduction state in FIG. 49, and after pit signals have ended the recording and reproduction signals SRW are recorded and/or reproduced approximately simultaneously.

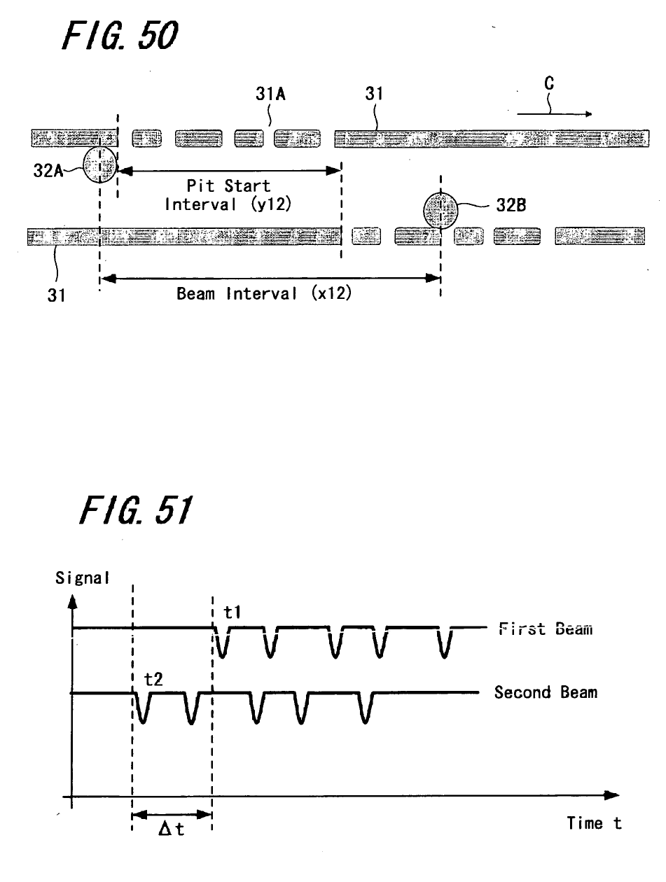

On the other hand, as shown schematically by the beam positioning diagram of FIG. 50, when the positioning interval x12 of the first and second beam spots 32A and 32B is larger than the pit start interval yl2, and the pit reproduction start time t2 for the second beam is earlier by time Δt than the pit reproduction start time t1 for the first beam, as indicated schematically by the pit reproduction signals in FIG. 51, then the beam interval x12 is shifted from the pit start interval yl2, and can be computed from y12+a×Δt, where a is the beam linear velocity.

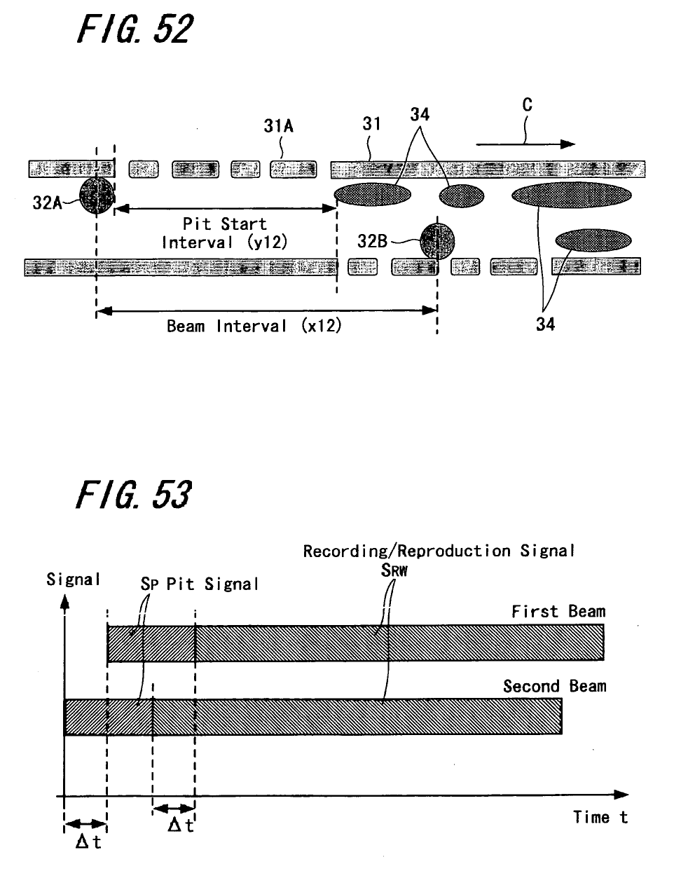

That is, as shown in FIG. 52, in this case the pits 31A are positioned in the guide track 31 at predetermined positions immediately before the recording and/or reproduction start position for recording signals 34, and as indicated in FIG. 53, the signal reproduction state is controlled such that at time Δt after reproduction of the pit signal SP by the second beam, recording and/or reproduction of recording and reproduction signals SRW by the first beam begins.

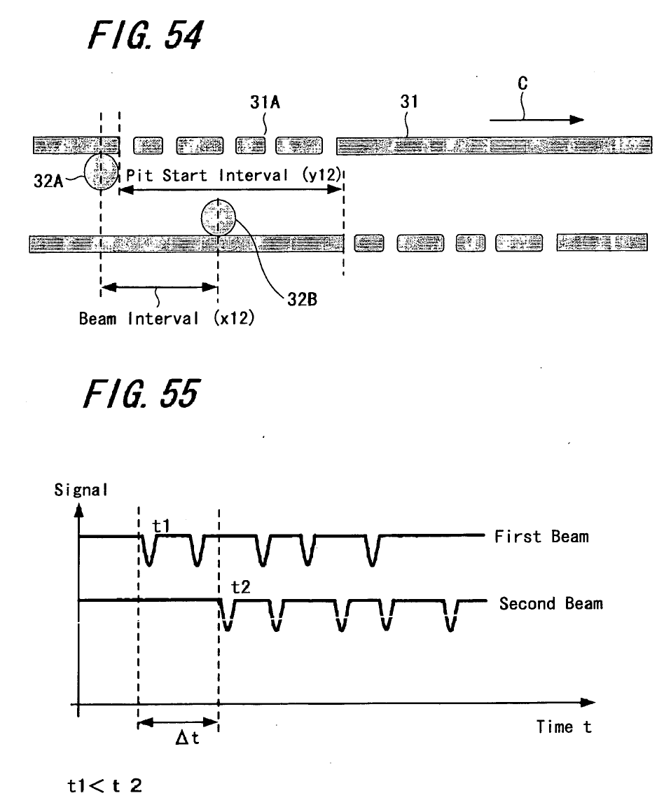

FIGS. 54 through 57 are used to explain a case in which, as shown in FIG. 54, the beam interval x12 is smaller than the pit start interval yl2. In this case, as shown schematically by the pit reproduction signal in FIG. 55, the pit reproduction signal by the first beam starts at a time earlier by Δt than the reproduction signal by the second beam. The beam interval x12 is shifted from the pit start interval yl2, and can be computed from y12−a×Δt, where a is the beam linear velocity.

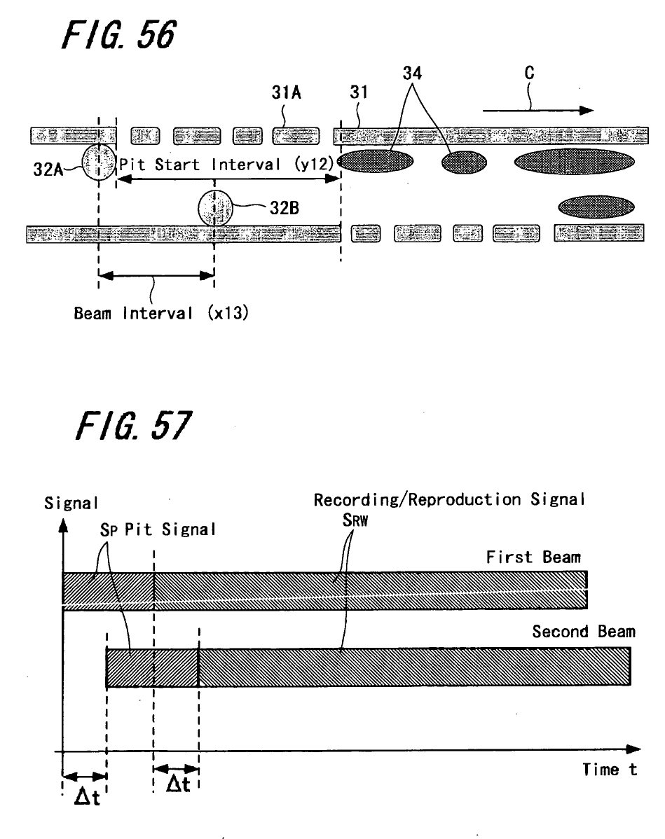

In this case also, as shown in FIG. 56, pits 31A are positioned in the guide track 31 at predetermined positions immediately before the recording and/or reproduction start position for recording signals 34, and as indicated in FIG. 57, signal reproduction is controlled such that at time Δt after reproduction of the pit signal SP by the first beam, recording and/or reproduction of recording and reproduction signals SRW by the second beam begins.

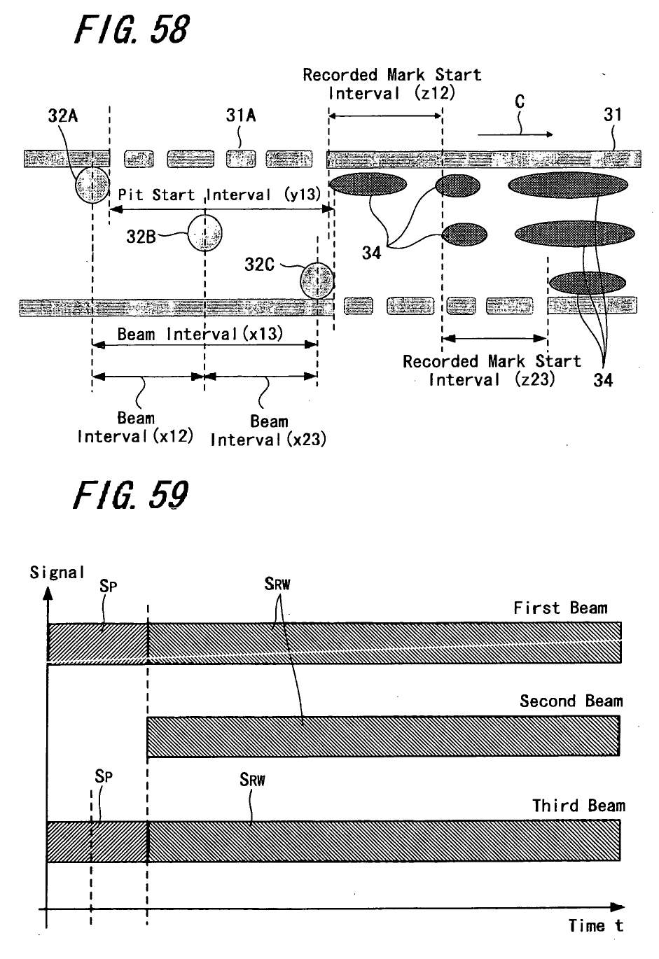

Next, a case is explained in which three beam spots are positioned between guide tracks. FIG. 58 shows a case in which first through third beam spots 32A, 32B, 32C are positioned between guide tracks 31. Assuming that the interval between the first and second beam spots be x12, the interval between the second and third beam spots be x23, and the interval between the first and third beam spots be x13, and the starting interval of pits 31A on the two guide tracks 31 be yl3. Further, the starting interval of recording marks for the first and second beams is z12, and the starting interval of recording marks for the second and third beams is z23.

In this case, as indicated schematically by the pit and recording mark recording and reproduction signals in FIG. 59, when the interval x13 between the first and third beam spots is approximately equal to the pit starting interval yl2, and the second beam spot is positioned approximately in the center position between the first and third beam spots, the pit reproduction signals SP for the first and third beam spots start approximately simultaneously, and thereafter the recording and reproduction signals SRW for the first through third beam spots start approximately simultaneously. That is, x12=x23.

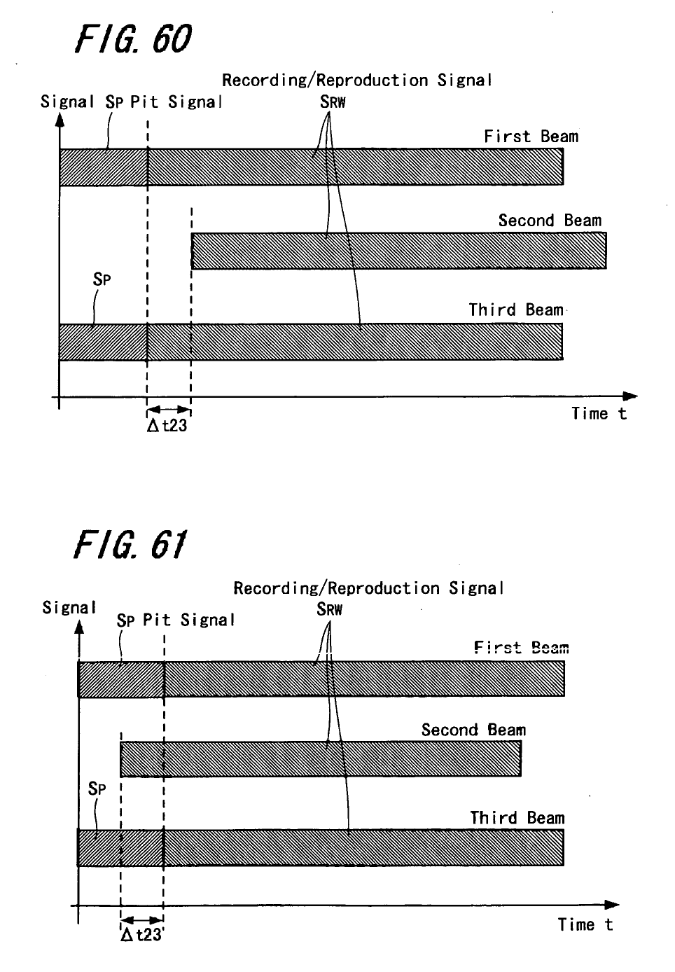

When the second beam spot is shifted from the center position between the first and third beam spots, the start time of recording and reproduction signals by the second beam spot is shifted. For example, if the second beam spot is shifted toward the first beam spot from the center position between the first and third beam spots, that is, shifted toward the opposite side to the direction of advance, then as shown in FIG. 60, the recording and reproduction signal start time for the second beam is delayed by Δt23 from the start time for the first and third beams. In this case, the interval x23 between the second and third beam spots, that is, the start interval z23 of recording marks for the second and third beams, is shifted from half the beam position interval x13 between the first and third beams, and is calculated from x13/2+a×Δt23, where a is the beam linear velocity. Similarly, the first and second beam spot interval x12, that is, the recording mark start interval z12 for the first and second beams, is x13/2−a×Δt23.

Conversely, when the second beam spot is shifted in the direction of advance from the center position between the first and third beam spots, as shown in FIG. 61, the start time for recording and reproduction signals SRW for the second beam spot is earlier by a time Δt23, and the interval x23 between the second and third beams can be computed from x13/2−a×Δt23, while the interval x12 between the first and second beams can be computed from x13/2+a×Δt23.

FIGS. 60 and 61 are cases in which the beam interval x13 between the first and third beams is approximately the same as the pit starting interval yl2, when the relative magnitudes are different from this, the method explained in the above FIG. 50 through FIG. 57 can be used to adjust the beam interval.

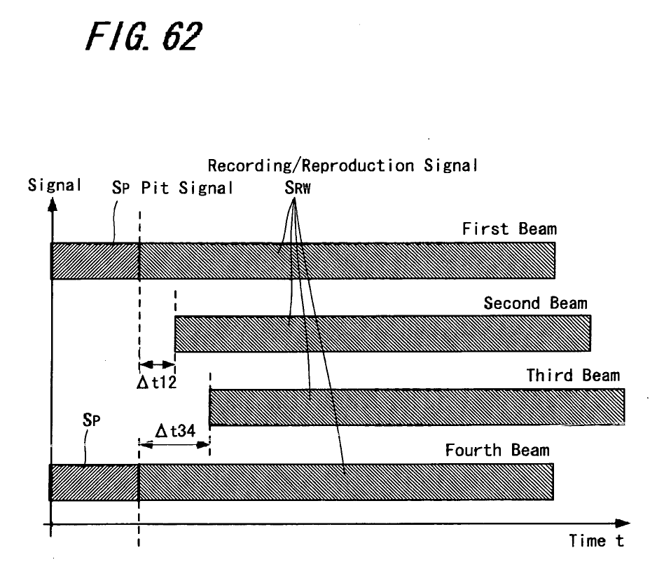

When four or more beam spots are employed, a similar method can be used to calculate the beam intervals from the pit start positions. FIG. 62 schematically shows pit signals and recording and reproduction signals for a case in which first through fourth beam spots are positioned. The shifts in the positions of the second and third beam spots from the positions of equal intervals between the first and fourth beam spots are respectively a×Δt12 and a×Δt34, where a is the linear velocity, Δtl2 is the difference in recording and reproduction start times for the first and second beam spots, and Δt34 is the difference in recording and reproduction start times for the third and fourth beam spots; and the respective beam spot intervals can be calculated by taking the sum (or difference) of these with ⅓ the interval x14 between the first and fourth beam spots.

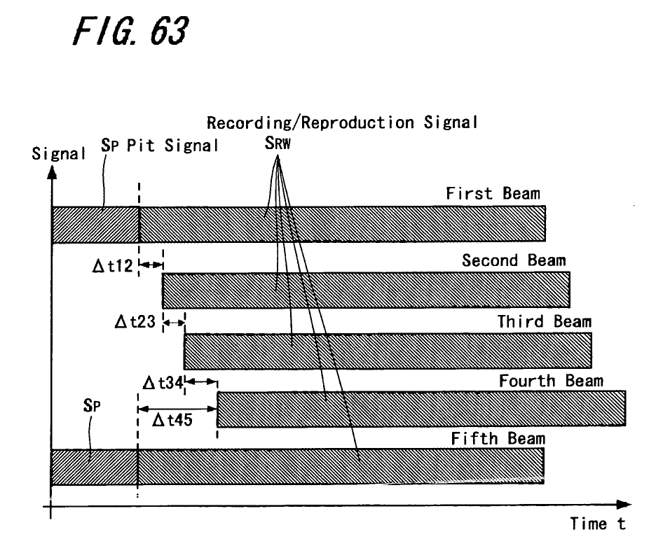

Similarly when five beam spots are employed, as shown in FIG. 63, the respective shifts in position can be calculated from the recording and reproduction start time differences Δtl2, Δt23, Δt34, Δt45 between the beam spots, and the beam position intervals can be calculated from these position shifts.

Thus when there are four or more beams, also the positions of beam spots can be calculated from the pit start positions; and in cases where the beam position interval at the two ends and the pit start interval are different, a method similar to the example explained in FIGS. 50 to 57 above can be used to calculate the position of each beam spot.

Thus in cases where a plurality of beam spots are provided at positions other than along a guide track also, the beam spot positions can be accurately calculated and recording and reproduction signals can easily be synchronized, so that stable near-field recording and reproduction at a high transfer rate are possible.

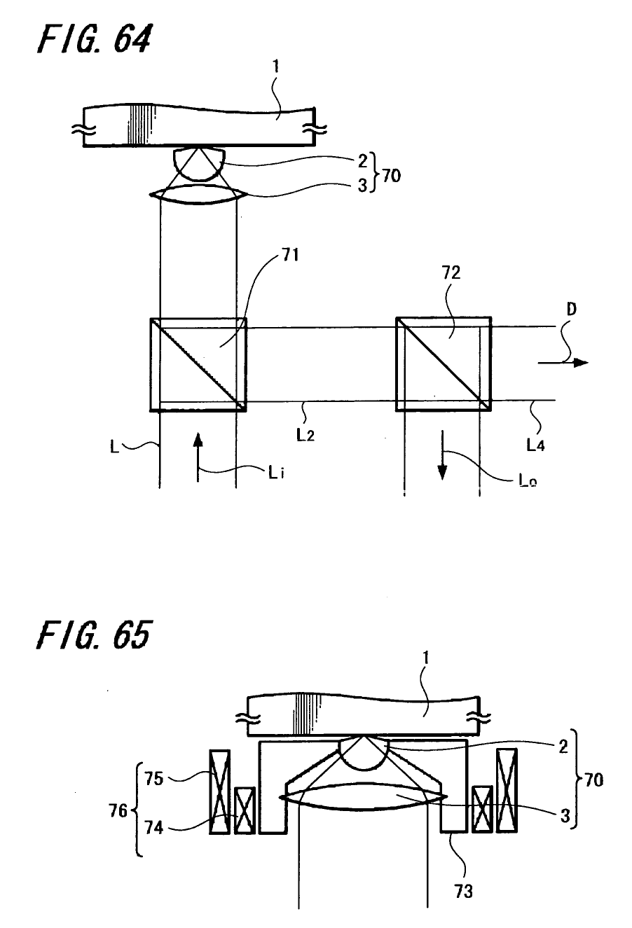

Next, FIGS. 64 and 65 are used to explain an example of an optical pickup device for near-field recording and reproduction to which this invention can be applied.

FIG. 64 schematically shows the configuration of the relevant part of an optical pickup device according to an embodiment of this invention; an example which uses a solid immersion lens (SIL) as the near-field light irradiation mechanism 2 is shown. A focusing lens 70 opposing the optical recording medium 1, includes near-field light irradiation mechanism 2 formed of the solid immersion lens and an optical lens 3 whose optical axes are made to coincide, in this order. The solid immersion lens 2 is, for example, a super-hemisphere in shape with radius r, and with thickness along the optical axis of r(1+1/n). By means of this configuration, a focusing lens 70 with a high numerical aperture exceeding the numerical aperture NA of the optical lens 3 can be provided.

In actuality, the near-field light irradiation mechanism 2 including a solid immersion lens and the optical recording medium 1 are not in mutual contact; but because the interval between the near-field light irradiation mechanism 2 and the optical recording medium 1 is very small compared with the thickness of the solid immersion lens of the near-field light irradiation mechanism 2, this interval is omitted in FIGS. 64 through 66.

Between a light source and photodetector, not shown, and this focusing lens 70, for example, first and second beam splitters 71 and 72 are positioned. The optical recording medium 1 is, for example, of disc shape, mounted on a spindle motor, not shown, and rotated at a predetermined rotation rate.

The focusing lens 70 is provided with mechanism for control and driving in the tracking direction and in the focusing direction. As such means, for example, a dual-axis actuator such as is commonly used in optical pickups, or a slider such as is used in magnetic head devices and similar, may be used.

The control and driving mechanism of the focusing lens 13 are described in the followings.

FIG. 65 schematically shows an example of an optical pickup device using a dual-axis actuator as the control and driving mechanism. As shown in FIG. 65, the focusing lens 70 includes near-field light irradiation mechanism 2 formed of, for example, a solid immersion lens and an optical lens 3, whose optical axes coincide and are held by a retaining portion 73; this retaining portion 73 is fixed to a dual-axis pickup 76 which is controlled and driven in the focusing direction and/or the tracking direction. The dual-axis pickup 76 includes a tracking coil 75, which controls and drives the focusing lens 70 in the tracking direction, and a focusing coil 74, which controls and drives the lens in the focusing direction.

By means of this dual-axis pickup 76, the distance (gap) between the optical recording medium 1 and the near-field light irradiation mechanism 2 can be controlled by, for example, monitoring the amount of totally reflected return light from the gap detection beam spot, and feeding back distance information, so that the distance between the near-field light irradiation mechanism 2 and the optical recording medium 1 is held nearly constant, and collisions between the near-field light avoided.

In this dual-axis pickup 76, the amount of return light in the tracking direction is monitored, and by feeding back the position information, focused spots can be moved along the desired recording tracks.

Hereinafter, FIG. 64 is further used to explain the schematic configuration of an optical pickup device. Light emitted from a light source, for example, a semiconductor laser, is converted into parallel light (Li) by a collimating lens (not shown), passes through a first beam splitter 71 and a focusing lens 70, and is focused on the information recording surface of the optical recording medium 1. Returning light (L2) reflected by the information recording surface passes through the focusing lens 70, is reflected by the first beam splitter 71, and is incident on the second beam splitter 72. The returning light (Lo) separated by this second beam splitter 72 is focused on a focusing photodetector and signal photodetector (not shown), and focusing error signals and reproduced pit signals and similar are detected.

Returning light reflected by the second beam splitter is also focused on a tracking photodetector, and a tracking error signal is detected. Note that if necessary the optical pickup device may be configured with a relay lens, inserted between the first beam splitter 71 and the optical lens 3, which, by changing the interval between the two lenses, corrects residual gap error components due to imperfect tracking of runout of the optical recording medium 1 by the dual-axis pickup to which the focusing lens 70 is fixed and error components occurring at the time of assembly of the focusing lens.

The above-described optical pickup device can be used as a read-only device for reproduction only, as a write-only device for recording only, or for both recording and for reproduction. Each of the above-described optical pickup devices can be provided with a configuration including a magnetic coil or similar as a portion of the optical pickup device, to combine a magneto-optical recording method with a near-field optical reproduction method. Optical recording and reproduction devices also include read-only devices which only perform reproduction, write-only devices which only perform recording, and recording and reproduction devices which perform both recording and reproduction.

Next, the lens shape is explained for a case in which a solid immersion lens (SIL) is used as the near-field light irradiation mechanism 2. When using a solid immersion lens, the approximately cross-sectional shape may be, for example, a super-hemisphere shape, as shown in FIG. 64; the objective surface, which is the surface opposing the optical recording this objective surface may be convex-spherical. The peripheral surface is used for fastening to the dual-axis pickup or to a slider.

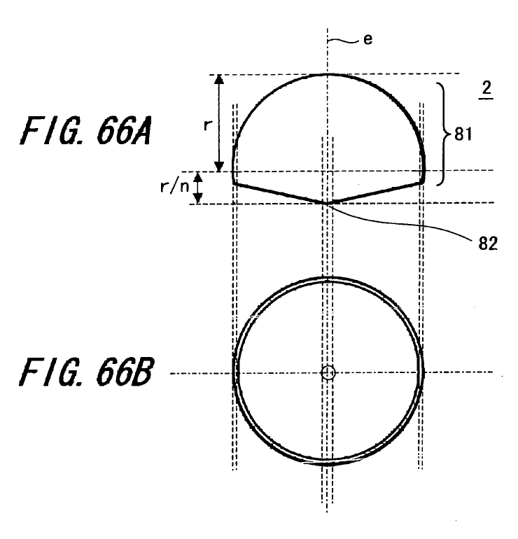

The gap or interval between this solid immersion lens and the optical recording medium is several tens of nanometers, as explained above, and in order to secure a mechanical inclination margin between the lens and the optical recording medium, machining into a conical shape or similar is appropriate within the range in which the angle of laser light incidence on the lens is not impeded, as shown in the schematic side view in FIG. 66A and the schematic plan view of the tip side in FIG. 66B. In the figures, the dot-dash line e represents the optical axis. In the example of FIG. 66, the tip side opposite the spherical portion 81 is formed into a conical shape, and the tip portion 82 has a plane shape.

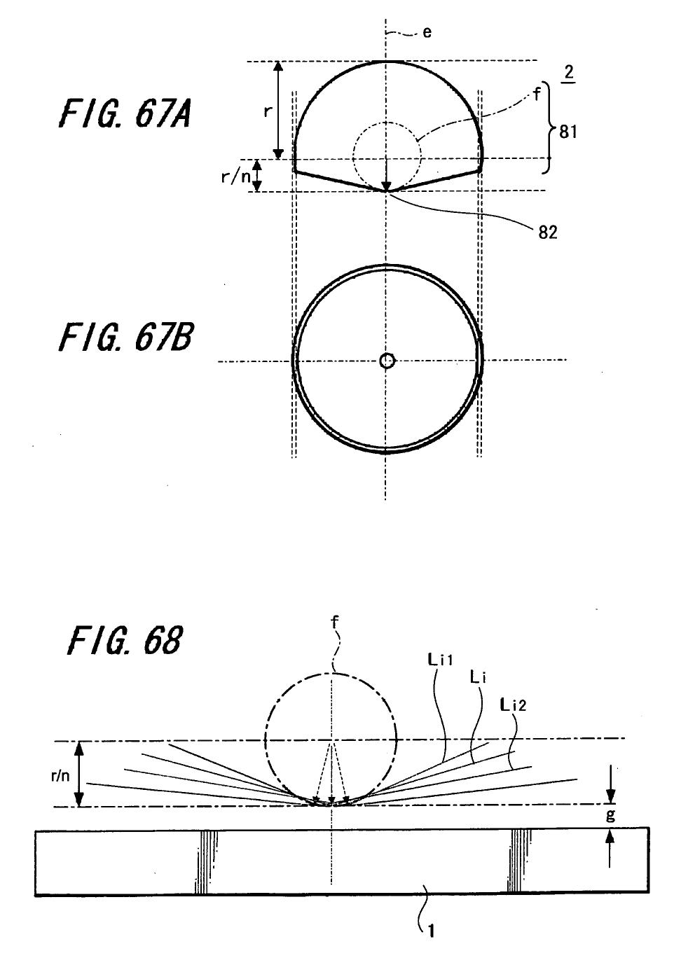

As shown in the side view and plan view of FIGS. 67A and 67B, the tip portion 82 may have a shape which approximately circumscribes a sphere of radius r/n, indicated by the dot-dash line f. In FIGS. 67A and 67B, portions corresponding to those in FIGS. 66A and 66B are assigned the same symbols, and redundant explanations are omitted. In this case, as shown in the enlarged sectional view of the tip portion in FIG. 68, even when the optical axis of incident light is shifted from the optical axis approximately no change in the path length of light passing through the lens, so that light can be collected at the tip portion 82. Hence stable recording and reproduction are possible, and even when detecting the interval g with the optical recording medium 1, fluctuations due to dispersion in the optical axis adjustment can be suppressed, and so there is the advantageous result that assembly tolerance can be relaxed.

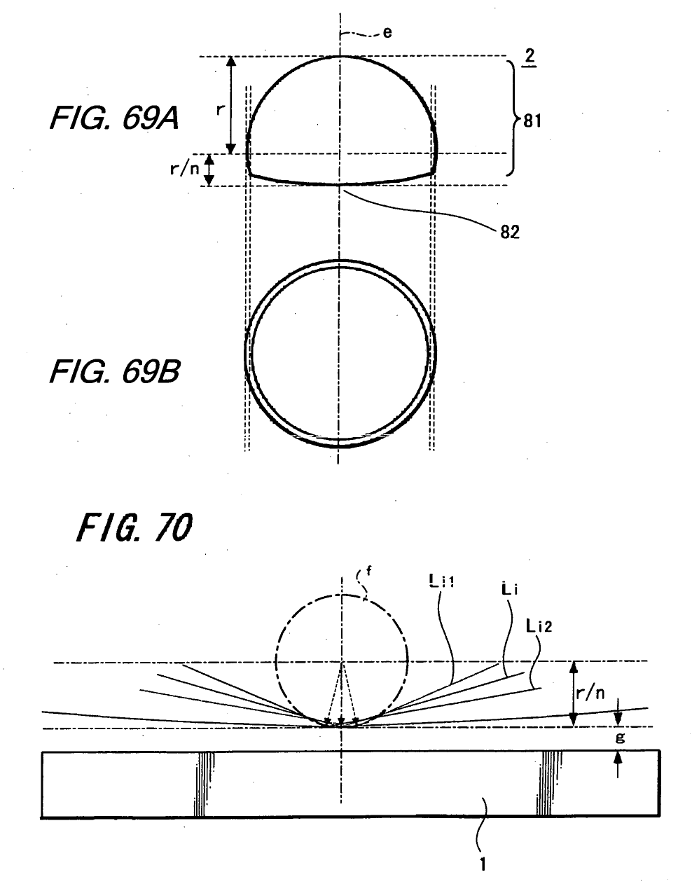

As shown in the schematic side view and plan view of FIGS. 69A and 69B, the tip portion can also be formed as a single curved surface. In FIG. 69A and FIG. 69B, portions corresponding to those in FIGS. 66A and 66B are assigned the same symbols, and redundant explanations are omitted. In this case also, as shown in the enlarged sectional view of the tip portion in FIG. 70, a similar advantageous result is obtained by forming the tip portion as a shape circumscribing a sphere of radius r/n.

In a method of near-field optical recording and reproduction of a magneto-optical recording medium, a magnetic field is necessary during recording and/or reproduction, and a configuration may be employed in which a magnetic coil or similar is mounted onto a portion of the objective surface of the solid immersion lens.

When using the above-described solid immersion lens as the near-field light irradiation mechanism, a material is appropriate which, for the wavelength of the laser light source included in the optical recording and reproduction device and for the wavelength used by the optical pickup device, has a large refractive index, high transmissivity, and small optical absorption. For example, the S-LAH79 high-refractivity glass of Ohara Inc., or high-refractivity ceramics, or the high-refractivity single-crystal materials Bi₄Ge₃O₁₂, SrTiO₃, KTaO₃, ZrO₂, HfO₂, SiC, diamond, GaP, and similar, are suitable.

It is preferable that these optical lens materials have either an amorphous structure, or, in the case of single crystals, a cubic structure. When an optical lens material has an amorphous structure or a cubic crystal structure, conventional mill grinding methods and equipment can be utilized. Further, there is no need to consider the crystal direction of the material, and etching processes and polishing processes for optical lens manufacture can readily be applied.

Next, practice examples are described.

(1) Practice Example 1

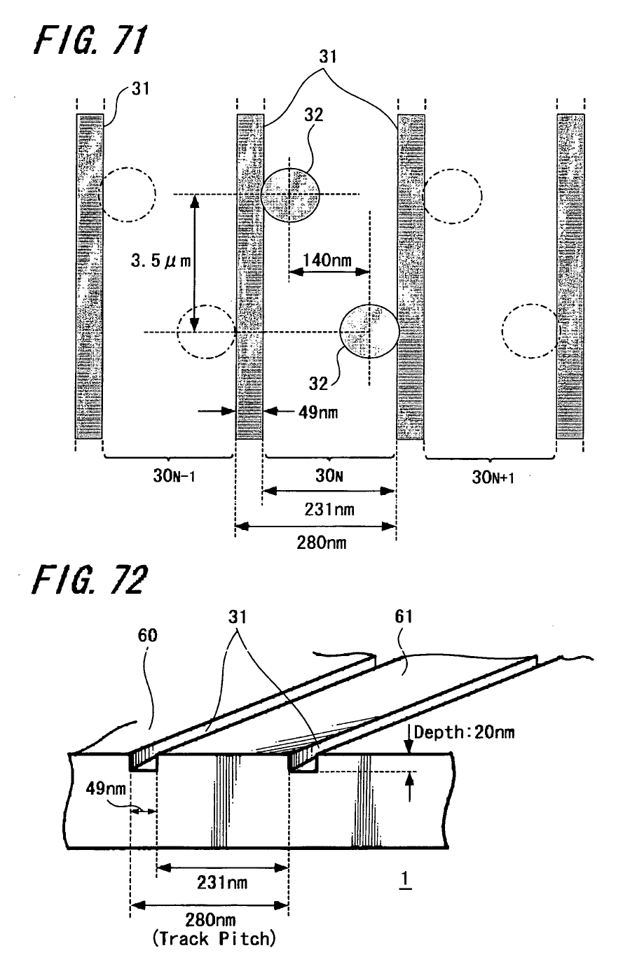

As Practice Example 1, two beam spots 32 were positioned between guide tracks 31 to perform near-field optical recording and reproduction, as shown in FIG. 71. The light source was a laser of wavelength 410 nm; the beam interval in the tangential direction, along the length direction of the guide tracks 31, was 140 nm; and the radial-direction beam interval was 3.5 μm The guide tracks had a groove shape; the interval between the recording guide grooves was 280 nm, the guide groove width was 49 nm, and the recording surface width was 231 nm. An enlarged perspective view of the optical recording medium 1 is shown in FIG. 72.

In the optical recording medium and optical pickup device of Practice Example 1 as shown in FIG. 71; two beam spots were positioned approximately symmetrically with respect to the interval between guide tracks 31, and adjacent to guide tracks 31, so that the guide tracks could be followed with good stability, and stable signals could also be obtained from pits, wobbles and similar apart from the guide track groove. Further, two recording and reproduction signals could be recorded in a single spiral-shape recording surface, so that even though the disc was not rotated at high speed, a high transfer rate for recording and reproduction was possible. That is, recording and reproduction could be performed at high transfer rates not easily achieved in the related art.

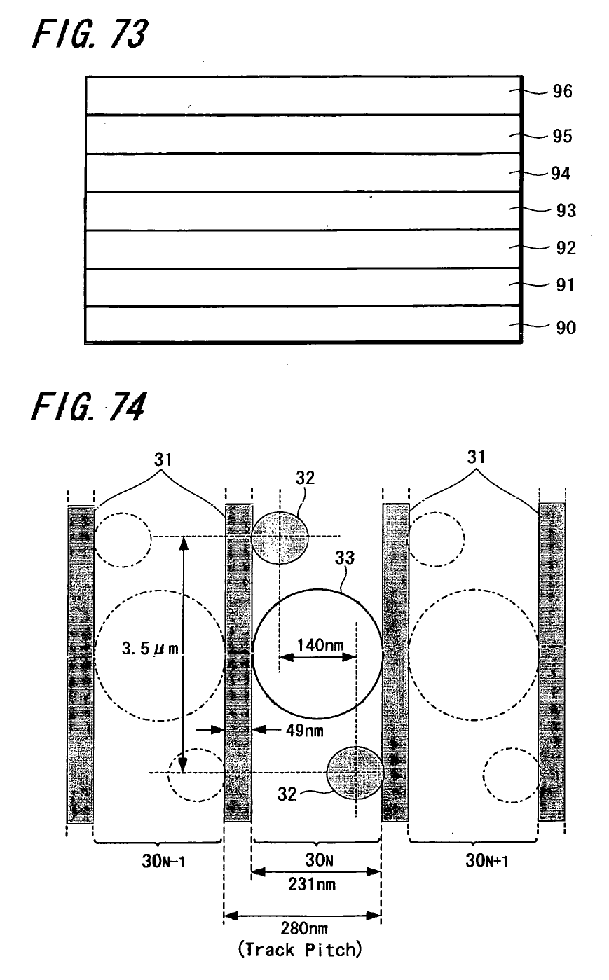

By means of this optical pickup device, an optical recording medium 1 with the phase-change recording configuration shown in FIG. 73 could be used for stable recording and reproduction at a high transfer rate. In this example, the optical recording medium was formed by depositing in order, on polycarbonate substrate 90, an Ag alloy layer 91, SiN layer 92, ZnS—SiO₂ layer 93, GeSbTe layer 94, ZnS—SiO₂ layer 95, and SiN layer 96. Satisfactory recording and reproduction characteristics were obtained.

(2) Practice Example 2

Next, in Practice Example 2 three beams were used; the wavelength of two lasers for recording and reproduction and for tracking were 410 nm, the beam interval in the tangential direction was 140 nm, and the radial-direction beam width was 3.5 μm. The wavelength of the single laser for the gap servo was 650 nm, and near-field optical recording and reproduction was performed with the gap servo beam spot positioned in the center of the guide track groove. FIG. 74 shows the beam positioning in the optical pickup device in this case. In this example also, the interval between guide tracks was 280 nm, the guide groove width was 49 nm, and the recording surface width was 231 nm; an optical recording medium with the layered configuration of FIG. 73 was used.

In this case also, two recording and reproduction beam spots were positioned symmetrically with respect to the interval between guide tracks, and were positioned adjacent to the guide tracks, so that recording tracks could be followed with good stability, and signals could be obtained with stability from pits, wobbles, and similar. Further, two recording and reproduction signals could be recorded onto a single spiral-shape recording surface, so that recording and reproduction at a high transfer rate were possible without rotating the disc at high speed. In Practice Example 2, apart from the two lasers laser used for the gap servo was positioned approximately in the center position of the recording and reproduction area, so that stable gap servo control was possible during recording in particular. That is, stable recording and reproduction of recording and reproduction signals with fast transfer, not easily achieved in the related art, was possible, and satisfactory recording and reproduction characteristics were obtained.

This invention is not limited to the above-explained embodiments, and various modifications and alterations are possible. For example, as the light source used in the optical pickup device or optical recording and reproduction device, for example, semiconductor lasers operating in the 780 nm band, 680 nm band, 660 nm band, 650 nm band, 635 nm band, 400 nm band, 415 nm band, and the like can be used.

As the near-field light irradiation mechanism, in addition to the above-described solid immersion lens, a solid immersion mirror (SIM) using a polygonal mirror can be employed, or various other mechanisms can be utilized.

Examples were explained in which multi-beam semiconductor lasers were used as light sources emitting a plurality of beams; in addition, a diffraction grating or other light separation mechanism can be used to separate light emitted from a single light source, to obtain a plurality of beam spots.

As explained above, in an optical recording and reproduction method, optical pickup device, optical recording and reproduction device, and optical recording medium of this invention, by positioning two or more beam spots in a recording and reproduction area on both sides of a guide track, a high rate of transfer of recording and reproduction signals, not attainable in the near-field optical pickup devices of the related art, can be achieved, without increasing the rate of disc rotation compared with the related art.

Further, by separating a plurality of beam spots into beam spots for recording and reproduction and beam spots for gap detection as described above, excellent control of the gap interval between the solid immersion lens or other near-field light irradiation mechanism and the optical recording medium is achieved, and the stability of recording and reproduction using optical recording medium can be improved. That is, if a near-field optical recording medium, a near-field optical pickup device, and a near-field optical recording and reproduction device of this invention are used, high transfer rates can easily be obtained in near-field recording and reproduction using a focusing lens with large numerical aperture. Hence an optical recording and reproduction method, optical pickup device, medium can be provided which enable high transfer rates and excellent recording and reproduction characteristics, and which are compatible with future high-density, large-capacity optical storage media.

It should be understood by those skilled in the art that various modifications, combinations, sub-combinations, and alterations may occur depending on design requirements and other factors insofar as they are within the scope of the appended claims or the equivalents thereof.

What is claimed is:

1. An optical recording and reproduction method comprising the steps of:
irradiating an optical recording medium with near-field light, and
positioning two or more recording and reproduction beam spots in a recording and reproduction area between guide tracks on said optical recording medium to perform recording and/or reproduction.

2. The optical recording and reproduction method according to claim 1,
wherein at least one among said beam spots, or one or a plurality of separately provided beam spots, are used as gap detection beam spots to detect the interval between said near-field light irradiation means and the surface of said optical recording medium.

3. The optical recording and reproduction method according to claim 2,
wherein said recording and reproduction beam spots, and said gap detection beam spots, use light at least the wavelength of which is different.

4. The optical recording and reproduction method according to claim 1,
wherein at least said recording and reproduction beam spots are positioned at approximately equal intervals in the recording and reproduction area between said guide tracks.

5. The optical recording and reproduction method according to claim 2, wherein
said gap detection beam spots are positioned at approximately the center position of, or at positions symmetrical about the center position of, the recording and reproduction area between said guide tracks.

6. The optical recording and reproduction method according to claim 1, wherein
beam position intervals between said two or more beam spots for recording and reproduction are calculated using the starting interval distances between any among guide tracks, pits, wobbles, or recording marks, positioned on said optical recording medium.

7. An optical pickup device comprising at least near-field light irradiation means to irradiate optical recording medium with light from a light source,
wherein two or more recording and reproduction beam spots are positioned in a recording and reproduction area between guide tracks on said optical recording medium.

8. The optical pickup device according to claim 7,
wherein at least one among said beam spots, or one or a plurality of separately provided beam spots, are used as gap detection beam spots to detect the interval between said near-field light irradiation means and the surface of said optical recording medium.

9. The optical pickup device according to claim 8,
wherein said recording and reproduction beam spots, and said gap detection beam spots, use light at least the wavelength of which is different.

10. The optical pickup device according to claim 7,
wherein at least said recording and reproduction beam spots are positioned at approximately equal intervals in the recording and reproduction area between said guide tracks.

11. The optical pickup device according to claim 8,
wherein said gap detection beam spots are positioned at approximately the center position of, or at positions symmetrical about the center position of, the recording and reproduction area between said guide tracks.

12. The optical pickup device according to claim 7,
wherein beam position intervals between said two or more recording and reproduction beam snots are calculated using the starting interval distances between any among guide tracks, pits, wobbles, or recording marks, positioned on said optical recording medium.

13. An optical recording and reproduction device comprising at least near-field light irradiation means to irradiate an optical recording medium with light from a light source and perform recording and/or reproduction,
wherein two or more recording and reproduction beam spots are positioned in a recording and reproduction area between guide tracks on said optical recording medium.

14. The optical recording and reproduction device according to claim 13,
wherein at least one among said beam spots, or one or a plurality of separately provided beam spots, are used as gap detection beam spots to detect the interval between said near-field light irradiation means and the surface of said optical recording medium.

15. An optical recording medium irradiated with near-field light to perform recording and/or reproduction, comprising:
two or more recording tracks, in which recording and/or reproduction are performed synchronously, positioned in an area between guide tracks.

16. An optical recording and reproduction method comprising the steps of:
irradiating an optical recording medium with near-field light,
positioning two or more recording and reproduction beam spots in a recording and reproduction area between guide tracks on said optical recording medium to perform recording and/or reproduction, and
positioning a gap detection beam spot to detect the interval between near-field light irradiation means and the surface of said optical recording medium on said guide tracks.

17. The optical recording and reproduction method according to claim 16,
wherein said recording and reproduction beam spots and said gap detection beam spot, use light at least the wavelength of which is different.

18. The optical recording and reproduction method according to claim 16,
wherein at least said recording and reproduction beam spots are positioned at approximately equal intervals in the recording and reproduction area between said guide tracks.

19. The optical recording and reproduction method according to claim 16,
wherein beam position intervals between said two or more recording and reproduction beam spots are calculated using the starting interval distances between any among guide tracks, pits, wobbles, or recording marks, positioned on said optical recording medium.

20. An optical pickup device comprising at least near-field light irradiation means to irradiate an optical recording medium with light from a light source,
wherein two or more recording and reproduction beam spots are positioned in a recording and reproduction area between guide tracks on said optical recording medium to perform recording and/or reproduction, and
a gap detection beam spot to detect the interval between said near-field light irradiation means and the surface of said optical recording medium is positioned on said guide tracks.

21. The optical pickup device according to claim 20,
wherein said recording and reproduction beam spots and said gap detection beam spot, use light at least the wavelength of which is different.

22. The optical pickup device according to claim 20,
wherein at least said recording and reproduction beam spots are positioned at approximately equal intervals in the recording and reproduction area between said guide tracks.

23. The optical pickup device according to claim 20,
wherein beam position intervals between said two or more recording and reproduction beam spots are calculated using the starting interval distances between any among guide tracks, pits, wobbles, or recording marks, positioned on said optical recording medium.

24. An optical recording and reproduction devices comprising at least near-field light irradiation means to irradiate an optical recording medium with light from a light source and perform recording and/or reproduction,
wherein two or more recording and reproduction beam spots are positioned in a recording and reproduction area between guide tracks on said optical recording medium, and
a gap detection beam spot to detect the interval between said near-field light irradiation means and the surface of said optical recording medium is positioned on said guide tracks.

25. A method of manufacturing an optical recording medium for recording and/or reproduction using near-field light, comprising the step of:
forming at least a portion of the guide tracks, pits, or wobbles of an optical recording medium master used in manufacturing said optical recording medium by high-speed blanking lithography using an electron lithography system.

26. A semiconductor laser device comprising:
two or more semiconductor lasers stacked,
wherein at least one of said semiconductor lasers has two or more emission surfaces, and
either at least one emission surface among, all the emission surfaces of said semiconductor lasers is positioned approximately in the center position of the line connecting both ends of the array of other emission surfaces, or two or more emission surfaces are positioned at position symmetrical about the center position.

27. The semiconductor laser device according to claim 26,
wherein the semiconductor laser having said emission surface positioned approximately at the center position or having emission surfaces positioned at positions symmetrical about the center position emits laser light at a wavelength different from that of other semiconductor lasers having emission surfaces.

28. An optical pickup device comprising at least near-field light irradiation mechanism to irradiate an optical recording medium with light from a light source,
wherein two or more recording and reproduction beam spots are positioned in a recording and reproduction area between guide tracks on said optical recording medium.

29. An optical recording and reproduction device comprising at least near-field light irradiation mechanism to irradiate an optical recording medium with light from a light source and perform recording and/or reproduction,
wherein two or more recording and reproduction beam spots are positioned in a recording and reproduction area between guide tracks on said optical recording medium.

30. An optical pickup device comprising at least near-field light irradiation mechanism to irradiate an optical recording medium with light from a light source,
wherein two or more recording and reproduction beam spots are positioned in a recording and reproduction area between guide tracks on said optical recording medium to perform recording and/or reproduction, and
a gap detection beam spot to detect the interval between said near-field light irradiation mechanism and the surface of said optical recording medium is positioned on said guide tracks.

31. An optical recording and reproduction device comprising at least near-field light irradiation mechanism to irradiate an optical recording medium with light from a light source and perform recording and/or reproduction,
wherein two or more recording and reproduction beam spots are positioned in a recording and reproduction area between guide tracks on said optical recording medium, and
a gap detection beam spot to detect the interval between said near-field light irradiation mechanism and the surface of said optical recording medium is positioned on said guide tracks.
